(19) United States
(12) Patent Application Publication
(10) Pub. No.: US 2021/0270863 A1
(43) Pub. Date: Sep. 2, 2021

(54) REAGENT MANAGEMENT APPARATUS, REAGENT MANAGEMENT SYSTEM, AND AUTOMATIC ANALYZER

(71) Applicant: CANON MEDICAL SYSTEMS CORPORATION, Otawara-shi (JP)

(72) Inventors: Arika KAMINAGA, Otawara (JP); Satoru SUGITA, Nasushiobara (JP)

(73) Assignee: CANON MEDICAL SYSTEMS CORPORATION, Otawara-shi (JP)

(21) Appl. No.: 17/186,052

(22) Filed: Feb. 26, 2021

(30) Foreign Application Priority Data
Feb. 28, 2020 (JP) 2020-033958

(51) Int. Cl. G01N 35/10; G01N 35/00

(52) U.S. Cl. CPC G01N 35/1002; G01N 35/00663; G01N 2035/0427; G01N 2035/00673; G01N 2035/00306

(57) ABSTRACT

A reagent management apparatus according to the present disclosure includes a communicator configured to communicate with an automatic analyzer to acquire reagent information on reagents in the automatic analyzer, a memory configured to store stored reagent information on reagents in a reagent storage and the reagent information on the reagents in the automatic analyzer, and a stored reagent manger to manage the stored reagent information on the reagents in the reagent storage and the reagent information on the reagents in the automatic analyzer stored in the memory.

### CROSS REFERENCE TO RELATED APPLICATIONS

This application is based upon and claims the benefit of priority from the prior Japanese Patent Application No. 2020-33958, filed on Feb. 28, 2020, the entire contents of which are incorporated herein by reference.

### FIELD

Embodiments described herein relate generally to a reagent management apparatus, a reagent management system, and an automatic analyzer.

### BACKGROUND

An automatic analyzer has therein a plurality of reagents. Depending on the test item, one or more reagents are suitably selected and used for the analysis of a sample obtained from an object to be tested. Each reagent is filled into a 50 ml bottle or a 100 ml bottle, for example, and set at a reagent carousel of the automatic analyzer. When a reagent is almost used up, the automatic analyzer displays a reagent remaining amount notice on a display to suggest the user to resupply the reagent. Checking the notice, the user goes to a reagent storage for resupplying the reagent.

Although the reagent remaining amount notice is displayed on the display of the automatic analyzer, the user is not always in front of the automatic analyzer, and may not be see the reagent remaining amount notice soon. If the user does not see the reagent remaining amount notice and does not resupply the reagent, the reagent will be used up, and the automatic analyzer needs to stop the measurements. Furthermore, the user may need to take a note for or print the name or identification information of the reagent to be resupplied displayed on the display before going to the reagent storage for the resupply of the reagent. This takes some time.

### BRIEF DESCRIPTION OF THE DRAWINGS

FIG. 1 is a block diagram illustrating the entire structure of an automatic analysis system according to a first embodiment.

FIG. 2 is a block diagram illustrating an example of a configuration of an automatic analyzer included in the automatic analysis system shown in FIG. 1.

FIG. 3 is a perspective view showing an example of the structure of an analyzing executor included in the automatic analyzer shown in FIG. 2.

FIG. 4 is a perspective view showing an example of the structure of a reagent management system included in the automatic analysis system shown in FIG. 1.

FIG. 5 is a block diagram illustrating an example of the structure of a reagent management apparatus included in the reagent management system shown in FIG. 4.

FIG. 6 is a block diagram for explaining functions performed by processing circuitry included in the reagent management apparatus shown in FIG. 5.

FIG. 7 is a flowchart for explaining the processing steps of a reagent storing process performed by the reagent management apparatus shown in FIG. 5.

FIG. 8 is a diagram illustrating an example of a storage location instruction window displayed during the reagent storing process shown in FIG. 7.

FIG. 9 is a flowchart for explaining the processing steps of a reagent resupply process performed by the reagent management apparatus shown in FIG. 5.

FIG. 10 is a diagram illustrating an example of a storage location display window displayed during the reagent resupply process shown in FIG. 9.

FIG. 11 is a diagram illustrating an example of a remaining amount display window displayed during the reagent resupply process shown in FIG. 9.

FIG. 12 is a flowchart for explaining the processing steps of a reagent expiration date management process performed by a reagent management apparatus included in an automatic analysis system 1 according to a second embodiment.

FIG. 13 is a diagram illustrating an example of a storage location display window displayed during the reagent expiration date management process shown in FIG. 12.

FIG. 14 is a diagram showing an example of a remaining amount display window displayed during the reagent expiration date management process shown in FIG. 12.

FIG. 15 is a block diagram illustrating the entire structure of an automatic analysis system 1 according to a third embodiment.

FIG. 16 is a block diagram illustrating functions performed by processing circuitry included in a reagent management apparatus included in the automatic analysis system shown in FIG. 15.

FIG. 17 is a flowchart for explaining the processing steps of a reagent automatic order process performed by the reagent management apparatus included in the automatic analysis system shown in FIG. 15.

FIG. 18 is a flowchart for explaining the processing steps of a reagent resupply process performed by a reagent management apparatus according to a fourth embodiment.

FIG. 19 is a diagram illustrating an example of a storage location display window displayed during the reagent resupply process shown in FIG. 18.

FIG. 20 is a diagram illustrating an example of a remaining amount display window displayed during the reagent resupply process show in FIG. 18.

FIG. 21 is a flowchart for explaining the processing steps of a reagent shortage prediction process performed by a reagent management apparatus according to a fifth embodiment.

FIG. 22 is a diagram illustrating a storage location display window displayed during the reagent shortage prediction process shown in FIG. 21.

FIG. 23 is a diagram illustrating an example of a remaining amount display window displayed during the reagent shortage prediction process shown in FIG. 21.

FIG. 24 is a perspective view showing an example of the structure of a reagent management system in an automatic analysis system according to a sixth embodiment.

FIG. 25 is a flowchart for explaining the processing steps of a reagent storing process performed by a reagent management apparatus included in the automatic analysis system shown in FIG. 24.

FIG. 26 is an enlarged diagram of a lamp of a reagent management apparatus according to a seventh embodiment (in a state where character information for identifying an automatic analyzer in which a reagent should be resupplied is displayed).

FIG. 27 is an enlarged diagram of the lamp of the reagent management apparatus according to the seventh embodiment (in a state where character information for identifying a storage location of a reagent is displayed).

FIG. 28 is a perspective view showing an example of the structure of the reagent management system in which the lamp is emitting as shown in FIG. 26.

FIG. 29 is a perspective view showing an example of the structure of the reagent management system in which the lamp is emitting as shown in FIG. 27.

FIG. 30 is a block diagram illustrating an example of an internal configuration of a lamp according to the seventh embodiment.

### DETAILED DESCRIPTION

Embodiments of reagent management apparatuses and reagent management systems will now be described with reference to the accompanying drawings. In the following descriptions, elements having substantially the same structure and functions have the same numerical symbol, and the explanation of such elements is repeated only when it is necessary to do so.

### First Embodiment

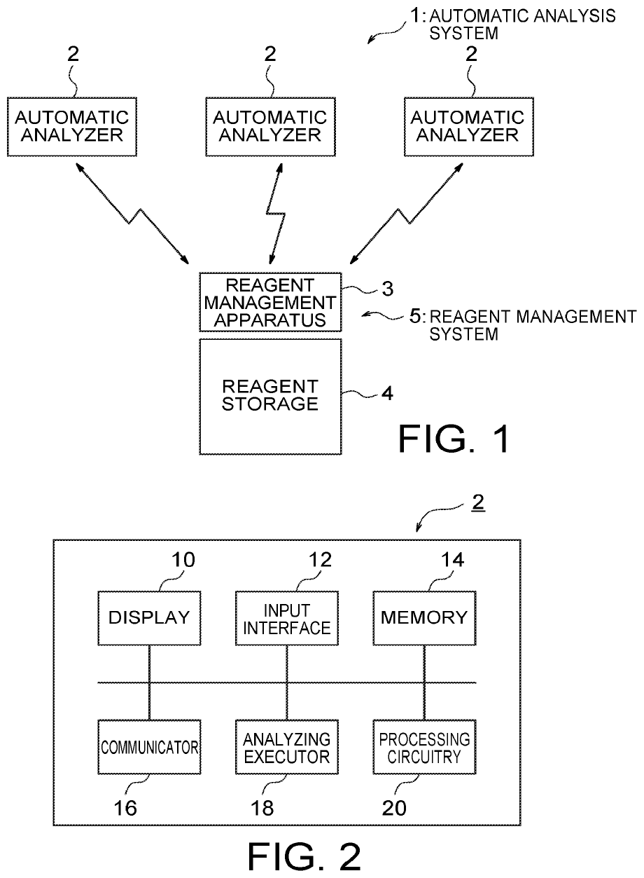

FIG. 1 is a block diagram illustrating the entire structure of an automatic analysis system 1 according to a first embodiment. As shown in FIG. 1, the automatic analysis system 1 according to the first embodiment includes one or more automatic analyzers 2, a reagent management apparatus 3 that may communicate with the automatic analyzers 2, and a reagent storage 4 that stores reagents used in the automatic analyzer 2. The reagent management apparatus 3 is included in the reagent storage 4. The reagent management apparatus 3 and the reagent storage 4 constitute a reagent management system 5 according to the first embodiment.

FIG. 2 is a block diagram illustrating an example of a configuration of the automatic analyzer 2 included in the automatic analysis system 1 shown in FIG. 1. As shown in FIG. 2, the automatic analyzer 2 according to the first embodiment includes a display 10, an input interface 12, a memory 14, a communicator 16, an analyzing executor 18, and processing circuitry 20. Those components are configured to cooperate with each other to operate via internal buses.

The display 10 displays various types of information. For example, the display 10 displays a processing result of the processing circuitry 20 and a graphical user interface (GUI) for receiving inputs from users. The display 10 also displays the remaining amount of each of the reagents used in the analyzing executor 18, and a reagent remaining amount notice that suggests that the user resupply a reagent when the remaining amount of the reagent decreases to a certain amount.

Examples of the display 10 include a liquid crystal display and a cathode ray tube (CRT) display.

Examples of the input interface 12 include a trackball, a switch button, a mouse device, and a keyboard for inputting various types of information to the automatic analyzer 2, a touchpad that receives an input caused by a touch action on its surface, a touchscreen including a display and a touchpad, a contactless input circuit including an optical sensor, and an audio input circuit. The input interface 12 is connected to the processing circuitry 20, converts the input from the user to an electrical signal, and outputs the electrical signal to the processing circuitry 20. The input interface 12 herein is not limited to those having a physical operation component such as a mouse device or a keyboard. For example, the examples of the input interface 12 may also include an electrical signal circuit that receives an electrical signal corresponding to an input from an external input device and outputs the electrical signal to the processing circuitry 20.

Examples of the memory 14 include a semiconductor memory device such as a random access memory (RAM) and a flash memory, a hard disk, and an optical disc. In the first embodiment, the memory 14 is a combination of a volatile memory device that temporarily stores information and a nonvolatile memory device that stores information in a nonvolatile manner. The memory 14 stores, for example, various processing programs required for the processing circuitry 20 to control and operate the analyzing executor 18, and various data items processed by the processing programs.

Examples of the communicator 16 include a wireless communication interface and a wired communication interface. In the first embodiment, for example, a wireless LAN (local area network) communication interface is used to exchange information with the reagent management apparatus 3 via wireless communication. In the first embodiment, the automatic analyzer 2 transmits reagent information to the reagent management apparatus 3 via the communicator 16. Examples of the reagent information include the type of reagent, the remaining amount of the reagent, and the expiration date of the reagent.

The analyzing executor 18 optically measures changes in color tone and turbidity caused by the reaction in a mixed solution containing a sample to be tested obtained from an object of the test and a reagent for the corresponding test item by means of a photometry unit such as a spectral photometer or a nephelometer. Since a different reagent may be used for each test item, the analyzing executor 18 stores a plurality of reagents and uses a suitable reagent for each test item. Therefore, the remaining amount of reagent may be different for each reagent. The analyzing executor 18 thus has a function to check the remaining amount of each reagent and displays the remaining amount on the display 10, and transmits reagent information including the remaining amount to the reagent management apparatus 3 via the communicator 16.

The processing circuitry 20 includes a processor, for example. In the first embodiment, the processing circuitry 20 performs a control operation required for the analysis performed by the automatic analyzer 2. The memory 14 stores programs needed for the control operation. For example, the processing circuitry 20 performs a function corresponding to a program by reading the program from the memory 14 and executing the program. Although FIG. 2 shows a single processor to perform the required function, the processing circuitry 20 may include a combination of independent processors each executing a program to achieve a required function. Furthermore, although FIG. 2 shows a single memory 14 for storing programs each corresponding to a processing function, a plurality of storage circuits may be provided and the processing circuitry 20 may read a required program from an independent storage circuit.

In the foregoing descriptions, an example in which the processor reads a program corresponding to a function from the memory 14 and executes the program has been described. However, the embodiments are not limited to this case. The term “processor” herein means circuitry such as a central processing unit (CPU), a graphics processing unit (GPU), an application specific integrated circuit (ASIC), a programmable logic device such as a simple programmable logic device (SPLD) and a complex programmable logic device (CPLD), and a field programmable gate array (FPGA). If the processor is a CPU, for example, the processor performs a function by reading a program stored in the memory 14 and executes the program. If the processor is an ASIC, the processor has the function realized as a logic circuit instead of storing a corresponding program in the memory 14.

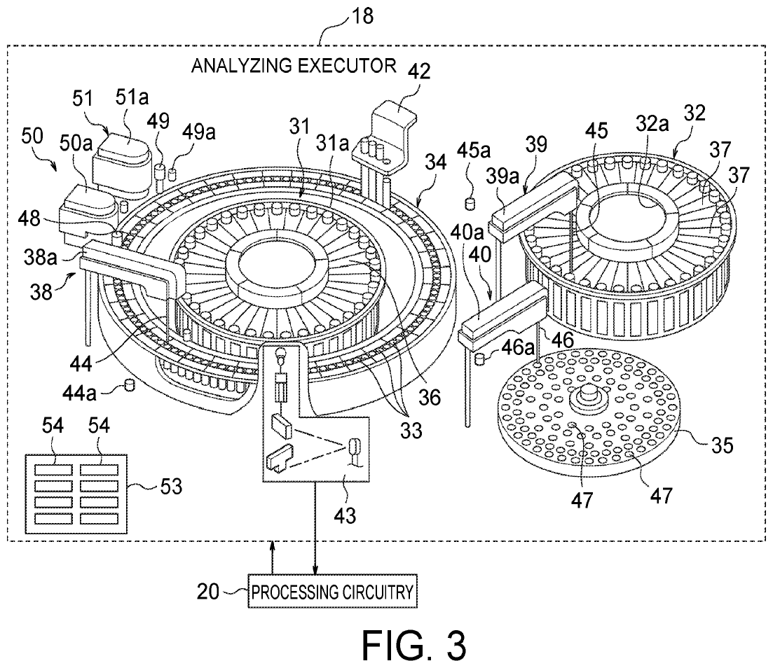

The structure of the analyzing executor 18 will be described in detail by referring to FIG. 3. FIG. 3 is a perspective view showing an example of the structure of the analyzing executor 18. As shown in FIG. 3, the analyzing executor 18 includes a reagent carousel 31, a reagent carousel 32, a reaction disk 34, and a sample disk 35. The reagent carousel 31 includes a reagent rack 31a that stores reagents 36 in a rotatable manner. The reagents 36 include first reagents to be reacted with an ingredient of the sample tested, the first reagents being classified into a one reagent system group and a two reagent system group.

The reagent carousel 32 also includes a reagent rack 32a that stores reagents 37 in a rotatable manner. The reagents 37 are second reagents corresponding to the first reagents classified into the two reagent system group. The reaction disk 34 holds a plurality of reaction containers 33 arranged on the periphery thereof in a rotatable manner. The sample disk 35 holds sample containers 47 that contain samples such as standard samples and samples to be tested.

The analyzing executor 18 according to the first embodiment also includes a sample dispensing mechanism 40, a first reagent dispensing mechanism 38, a second reagent dispensing mechanism 39, a first agitation mechanism 50, and a second agitation mechanism 51. The sample dispensing mechanism 40 has a sample dispensing arm 40a, a sample dispensing probe 46, and a cleaning tub 46a. The sample dispensing arm 40a holds the sample dispensing probe 46 in a rotatable and vertically movable manner. The sample dispensing probe 46 is used for a dispensing operation including an aspiration of a sample in one of the sample containers 47 held by the sample disk 35 by the sample dispensing probe 46 and a discharge of the sample into one of the reaction containers 33. The cleaning tub 46a is a solution tub used for cleaning the sample dispensing probe 46 after the sample is dispensed.

The first reagent dispensing mechanism 38 includes a first reagent dispensing arm 38a, a first reagent dispensing probe 44, and a cleaning tub 44a. The first reagent dispensing arm 38a holds the first reagent dispensing probe 44 in a rotatable and vertically movable manner. The first reagent dispensing probe 44 is used for a dispensing operation including an aspiration of one of the first reagents from the reagents 36 stored in the reagent carousel 31, and a discharge of the first reagent into the reaction container 33 to which the above-described sample has been discharged. The cleaning tub 44a is a solution tub used for cleaning the first reagent dispensing probe 44 after the first reagent is dispensed.

The second reagent dispensing mechanism 39 includes a second reagent dispensing arm 39a, a second reagent dispensing probe 45, and a cleaning tub 45a. The second reagent dispensing arm 39a holds the second reagent dispensing probe 45 in a rotatable and vertically movable manner. The second reagent dispensing probe 45 is used for a dispensing operation including an aspiration of one of the second reagents from the reagents 37 stored in the reagent carousel 32, and a discharge of the second reagent into the reaction container 33 to which the sample and the first reagent have been discharged. The cleaning tub 45a is a solution tub used for cleaning the second reagent dispensing probe 45 after the second reagent is dispensed.

The first agitation mechanism 50 includes a first agitation arm 50a, a first agitator 48, and a cleaning tub 48a. The first agitation arm 50a holds the first agitator 48 in a rotatable and vertically movable manner. The first agitator 48 agitates a mixed solution including the sample and the first reagent that have been discharged into the reaction container 33. The cleaning tub 48a is a solution tub used for cleaning the first agitator 48 after the mixed solution is agitated.

The second agitation mechanism 51 includes a second agitation arm 51a, a second agitator 49, and a cleaning tub 49a. The second agitation arm 51a holds the second agitator 49 in a rotatable and vertically movable manner. The second agitator 49 agitates a mixed solution including the sample, the first reagent, and the second reagent that have been discharged into the reaction container 33. The cleaning tub 49a is a solution tub used for cleaning the second agitator 49 after the mixed solution is agitated.

The analyzing executor 18 further includes a photometry unit 43 that optically measures the mixed solution in the reaction container 33 by emitting light to the mixed solution, and a cleaning unit 42 for cleaning the inside of the reaction container 33 after the measurement by the photometry unit 43 is completed.

The photometry unit 43 emits light to the reaction containers 33 passing through its light path, and generates, for example, standard data represented as absorbance data and subject data based on a detected signal which relies on passing light through the mixed solution in the reaction container 33 including the standard sample and the sample to be tested. The analyzing executor 18 then outputs the standard data and the subject data generated by the photometry unit 43 to the processing circuitry 20.

The processing circuitry 20 controls and drives analysis units of the analyzing executor 18. Specifically, the processing circuitry 20 controls a mechanism to rotate and stop the rotations of the sample disk 35, the reagent rack 31a of the reagent carousel 31, and the reagent rack 32a of the reagent carousel 32 in each analysis cycle, and controls a mechanism to rotate and stop the rotation of the reaction disk 34.

The processing circuitry 20 also drives the sample dispensing mechanism 40, the first reagent dispensing mechanism 38, the second reagent dispensing mechanism 39, the first agitation mechanism 50, and the second agitation mechanism 51, and controls the mechanisms for rotating and vertically moving the sample dispensing arm 40a, the first reagent dispensing arm 38a, the second reagent dispensing arm 39a, the first agitation arm 50a, and the second agitation arm 51a, the sample dispensing probe 46, the first reagent dispensing probe 44, and the second reagent dispensing probe 45 to perform the aspiration and the discharge operation.

The analyzing executor 18 according to the first embodiment further includes a resupply reagent storage 53. The resupply reagent storage 53 stores reagents 54. When one of the reagents 36 in the reagent carousel 31 is used up, or one of the reagents 37 in the reagent carousel 32 is used up, the same type of reagent 54 is mechanically sent from the resupply reagent storage 53 to the reagent carousel 31 or the reagent carousel 32 under the control of the processing circuitry 20, and replaced with the used-up reagent 36 or the used-up reagent 37.

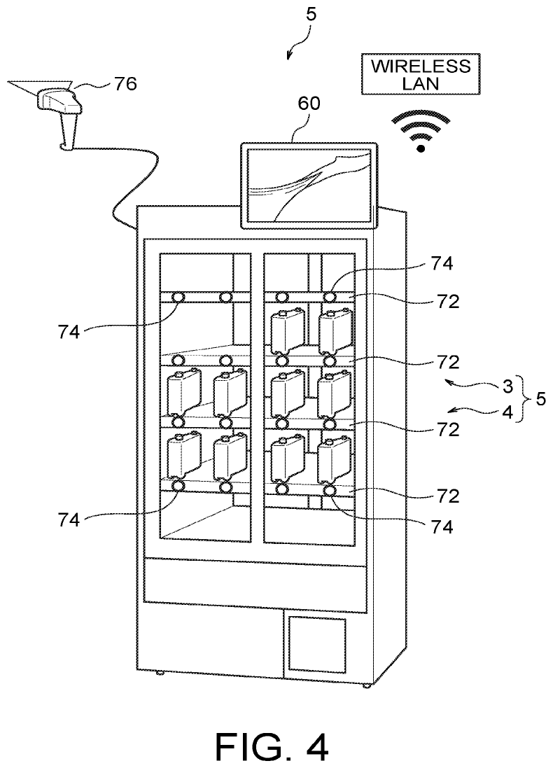

FIG. 4 is a perspective view showing an example of the structure of the reagent management system 5 included in the automatic analysis system 1 according to the first embodiment. As described above, the reagent management system 5 includes the reagent management apparatus 3 and the reagent storage 4.

As shown in FIG. 4, the reagent management apparatus 3 is communicatively connected to the automatic analyzer 2 to exchange information. The reagent storage 4 stores reagents, and includes a refrigerator or the like for maintaining the same temperature therein. The reagent management apparatus 3 may be installed to the reagent storage 4 when the reagent storage 4 is manufactured, or may be installed to the user's own reagent storage 4. The reagents stored in the reagent storage 4 are eventually sent to the automatic analyzer 2 and used as the reagents 36 or the reagents 37 shown in FIG. 3.

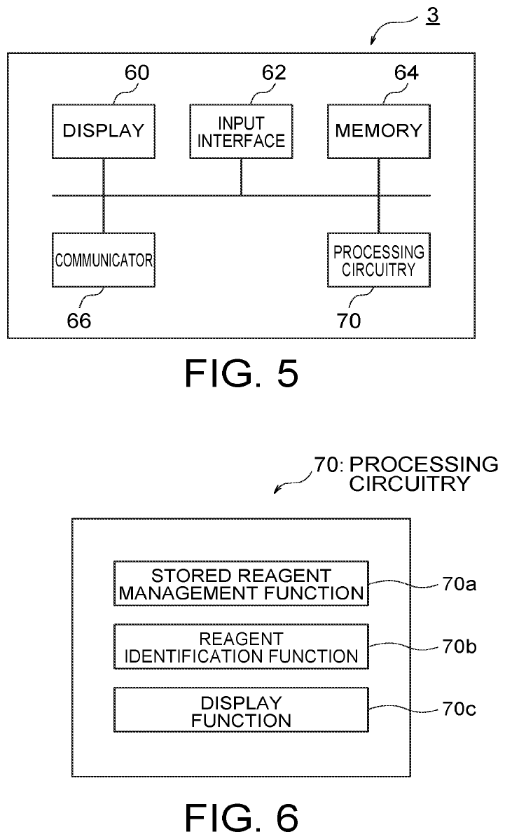

FIG. 5 is a block diagram illustrating an example of the structure of the reagent management apparatus 3 included in the reagent management system 5 according to the first embodiment. FIG. 6 is a block diagram showing functions performed by processing circuitry 70 included in the reagent management apparatus 3.

As shown in FIG. 5, the reagent management apparatus 3 according to the first embodiment includes a display 60, an input interface 62, a memory 64, a communicator 66, and the processing circuitry 70. Those components are configured to cooperate with each other to operate via internal buses.

The display 60 displays various types of information. For example, the display 60 displays a processing result of the processing circuitry 70 and a graphical user interface (GUI) for receiving inputs from users. The display 60 also displays the remaining amount of each of the reagents obtained from the automatic analyzer 2, and a reagent remaining amount notice that suggests that the user resupply a reagent when the remaining amount of the reagent decreases to a certain amount. Examples of the display 60 include a liquid crystal display and a cathode ray tube (CRT) display.

In the first embodiment, as shown in FIG. 4, lamps 74 provided to shelves 72 of the reagent storage 4 also constitutes the display 60. Specifically, the reagent storage 4 includes one or more shelves 72 to which lamps 74 are arranged. In the first embodiment, one of the lamps 74 is disposed to each location where a reagent is stored. In other words, a one-to-one relationship is established between the locations where reagents are stored and the lamps 74. Since the reagent storage 4 shown in FIG. 4 has four shelves 72 on each of which four reagents are arranged, 16 reagents may be stored in the reagent storage 4. Therefore, 16 lamps 74 are provided to the reagent storage 4.

Examples of the input interface 62 include a trackball, a switch button, a mouse device, and a keyboard for inputting various types of information to the reagent management apparatus 3, a touchpad that receives an input caused by a touch action on its surface, a touchscreen including a display and a touchpad, a contactless input circuit including an optical sensor, and an audio input circuit. In the first embodiment, the display 60 is a touchscreen, and the user makes various selections and makes various inputs by touching the display 60.

The input interface 62 also includes a barcode reader 76 in the first embodiment. The barcode reader 76 reads a barcode printed or attached on the container of the reagent to input such information as the type and the expiration date of the reagent to the reagent management apparatus 3. The lamps 74 also constitute the input interface 62 in the first embodiment. The lamp 74 therefore has a lighting function and a push button function to input a signal to the reagent management apparatus 3 when the user pushes down the lamp 74.

The input interface 62 is connected to the processing circuitry 70, converts the input from the user to an electrical signal, and outputs the electrical signal to the processing circuitry 70. The input interface 62 herein is not limited to those having a physical operation component such as a mouse device or a keyboard. For example, the examples of the input interface 62 may also include an electrical signal circuit that receives an electrical signal corresponding to an input from an external input device provided external to the reagent management apparatus 3 and outputs the electrical signal to the processing circuitry 70.

Examples of the memory 64 include a semiconductor memory device such as a random access memory (RAM) and a flash memory, a hard disk, and an optical disc. In the first embodiment, the memory 64 is a combination of a volatile memory device that temporarily stores information and a nonvolatile memory device that stores information in a nonvolatile manner. The memory 64 stores, for example, various processing programs required for the processing circuitry 70 to control and operate the reagent management apparatus 3, and various data items processed by the processing programs.

Examples of the communicator 66 include a wireless communication interface and a wired communication interface. In the first embodiment, for example, a wireless LAN (local area network) communication interface is used to exchange information with each of the automatic analyzers 2. In the first embodiment, the reagent management apparatus 3 obtains reagent information held by each of the automatic analyzers 2 via the communicator 16. Examples of the reagent information include the type of reagent, the remaining amount of the reagent, and the expiration date of the reagent.

The processing circuitry 70 includes a processor, for example. In the first embodiment, the processing circuitry 70 controls the reagent management apparatus 3. The memory 64 stores programs needed for the control operation. For example, the processing circuitry 70 performs a stored reagent management function 70a, a reagent identification function 70b, and a display function 70c shown in FIG. 6 by reading and executing the corresponding programs from the memory 64. Although FIG. 5 shows a single processor to perform the required functions, the processing circuitry 70 may include a combination of independent processors each executing a program to perform the stored reagent management function 70a, the reagent identification function 70b, or the display function 70c shown in FIG. 6. Furthermore, although FIG. 5 shows a single memory 64 for storing the programs each corresponding to one of the processing functions, a plurality of storage circuits may be provided and the processing circuitry 70 may read a required program from an independent storage circuit.

The stored reagent management function 70a, the reagent identification function 70b and the display function 70c shown in FIG. 6 correspond to stored reagent manager, reagent identifier, and display of the first embodiment, respectively.

In the foregoing descriptions, an example in which the processor reads a program corresponding to a function from the memory 64 and executes the program has been described. However, the embodiments are not limited to this case. The term “processor” herein means circuitry such as a central processing unit (CPU), a graphics processing unit (GPU), an application specific integrated circuit (ASIC), a programmable logic device such as a simple programmable logic device (SPLD) and a complex programmable logic device (CPLD), and a field programmable gate array (FPGA). If the processor is a CPU, for example, the processor performs a function by reading a program stored in the memory 64 and executes the program. If the processor is an ASIC, the processor has the function realized as a logic circuit instead of storing a corresponding program stored in the memory 64.

In the reagent management apparatus 3 according to the first embodiment, the display 60 includes therein the input interface 62, the memory 64, the communicator 66, and the processing circuitry 70 to form a mobile device such a so-called notepad or tablet having mobility. The input interface 62, the memory 64, the communicator 66, and the processing circuitry 70 are not necessarily included in the display 60 and may be disposed external to the display 60.

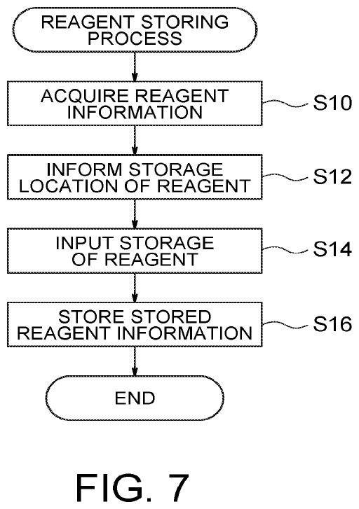

The processes performed by the reagent management apparatus 3 according to the first embodiment will now be described in detail. FIG. 7 is a flowchart for explaining the processing steps of a reagent storing process performed by the reagent management apparatus 3 according to the first embodiment. The reagent storing process is performed when the user stores a new reagent in the reagent storage 4. In the first embodiment, the reagent storing process is performed when, for example, the user commands the activation of the reagent storing process through the input interface 62 when storing a new reagent in the reagent storage 4.

As shown in FIG. 7, in the reagent storing process, the stored reagent management function 70a performed by the processing circuitry 70 included in the reagent management apparatus 3 acquires reagent information of a reagent to be newly stored in the reagent storage 4 (step S10). For example, in the first embodiment, the reagent information is acquired by asking the user to read a barcode printed on the container of the reagent to be newly stored by using the barcode reader 76.

The acquired reagent information includes a bottle code showing the manufacturer and the type of the reagent, a bottle type indicating the size of the container of the reagent, the expiration date of the reagent, and the lot number of the reagent. The reagent information in the first embodiment does not necessarily have all of the above-described items but may include part of the items. Furthermore, the reagent information may include other information items.

Next, the stored reagent management function 70a performed by the processing circuitry 70 included in the reagent management apparatus 3 identifies the type of the reagent based on the reagent information and the storage location of the reagent, and informs the user of the type (step S12). In the first embodiment, for example, the display function 70c tunes on the lamp 74 provided to one of the shelves 72 where the reagent is to be stored to emit green light. The user stores the reagent at the location of the lamp 74 having been turned on to emit green light.

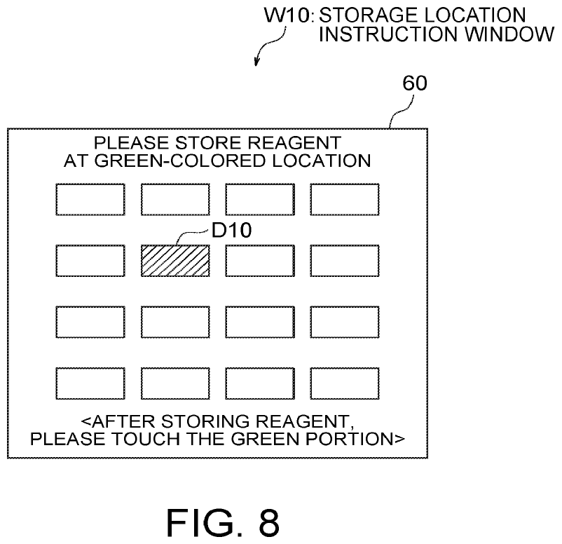

Alternatively, the stored reagent management function 70a performed by the processing circuitry 70 included in the reagent management apparatus 3 causes the display function 70c to display a storage location instruction window W10 as shown in FIG. 8 on the display 60. In the storage location instruction window W10, a storage location D10 where the reagent should be stored may be informed to the user by being colored green, and the other storage locations may be colored white. Thus, the display 60 may display a window showing the layout of the reagent storage 4 in which the storage location where the reagent should be stored is indicated to inform the user of the storage location.

Next, as shown in FIG. 7, the stored reagent management function 70a performed by the processing circuitry 70 included in the reagent management apparatus 3 instructs the user input the completion of the storage of the reagent so that the reagent storage at the instructed location may be detected (step S14). In the first embodiment, the storage of the reagent at the instructed location is detected when the user pushes down the lamp 74 emitting green light upon the completion of the storage of the reagent. The stored reagent management function 70a may confirm the storage of the reagent at the correct location of the reagent storage 4 by checking the location of the lamp 74 pushed down by the user.

Alternatively, the stored reagent management function 70a performed by the processing circuitry 70 included in the reagent management apparatus 3 may cause the display function 70c to display the storage location instruction window W10 shown FIG. 8, and instruct the user to touch the green portion of the storage location D10 after storing the reagent at the storage location D10. Thus, the user may input the completion of the storage of the reagent at the instructed location by means of the input interface 62 including a touch panel.

Next, as shown in FIG. 7, the stored reagent management function 70a performed by the processing circuitry 70 included in the reagent management apparatus 3 associates the information on the storage location of the reagent with the reagent information of the reagent, and store the information as stored reagent information in the memory 64 (step S16). As a result, the reagent management apparatus 3 may manage the stored reagent information including the types and the storage locations of the reagents stored in the reagent storage 4. After step S16 is performed, the reagent storing process according to the first embodiment ends.

In the reagent storing process, the instruction of the storage location of the reagent in step S12 may be omitted. In this case, the user understands that the new reagent may be stored at an arbitrarily selected location since no lamp 74 is turned on after the reagent information of the reagent to be stored is read by the barcode reader 76 in step S10. The user then stores the new reagent at a vacant storage location on the shelves 72. The user then inputs the storage location to the reagent management apparatus 3 by pushing down the lamp 74 at the storage location. The reagent management apparatus 3 may identify the storage location of the new reagent by the input, and causes the memory 64 to store the stored reagent information including the storage location of the reagent associated with the reagent information.

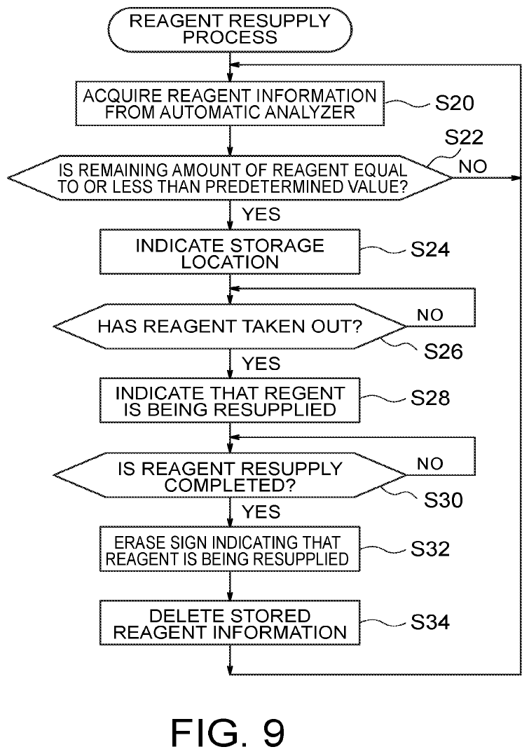

A reagent resupply process performed by the reagent management apparatus 3 according to the first embodiment will then be described. FIG. 9 is a flowchart for explaining the processing steps of the reagent resupply process performed by the reagent management apparatus 3 according to the first embodiment. The reagent resupply process is regularly performed by the reagent management apparatus 3. In the first embodiment, the reagent resupply process is performed at predetermined intervals such as 10 minutes or one hour. The reagent resupply process is performed independently for each of the automatic analyzers 2 communicatively connected to the reagent management apparatus 3. If the reagent management apparatus 3 manages the reagents for two automatic analyzers 2, for example, two reagent resupply processes are performed in parallel. Although the reagent resupply process performed for a single automatic analyzer 2 managed by the reagent management apparatus 3 will be described below, in the automatic analysis system 1 according to the first embodiment shown in FIG. 1, the reagent resupply process is performed for each of a plurality of automatic analyzers 2.

As shown in FIG. 9, in the reagent resupply process, the reagent identification function 70b performed by the processing circuitry 70 included in the reagent management apparatus 3 acquires reagent information from the automatic analyzer 2 via the communicator 66 (step S20). In the first embodiment, the reagent information means reagent information for all of the reagents used in the automatic analyzer 2. The reagent information at least includes information for identifying the types of reagents and the remaining amount of each of the reagents.

The reagent identification function 70b performed by the processing circuitry 70 included in the reagent management apparatus 3 then determines whether there is a reagent that needs to be resupplied by checking whether the remaining amount of any of the reagents acquired in step S20 is equal to or less than a predetermined value (step S22). If there is a reagent that needs to be resupplied (step S22: Yes), the reagent identification function 70b causes the display function 70c to indicate the storage location in the reagent storage 4 where the reagent of the same type as the reagent for which the remaining amount is equal to or less than the predetermined value is stocked, in order to notify the user of the storage location (step S24).

For example, in the first embodiment, the lamp 74 at the storage location of the reagent for the resupplying is turn on to notify the storage location of the reagent for the resupplying to the user. In the first embodiment, the color of the lamp is changed depending on the remaining amount of the reagent. For example, a first threshold value (30%) and a second threshold value (10%) that is lower than the first threshold value are set for the remaining amount of the reagent, and if the remaining amount of the reagent is equal to or less than the first threshold value and greater than the second threshold value, the lamp 74 at the storage location of the reagent for the resupplying is turned on to emit yellow light to give a first warning to the user to draw the user's attention. When the remaining amount of the reagent further decreases and becomes less than the second threshold value, the color of the lamp 74 at the storage location of the reagent for the resupplying is changed to red to give a second warning to inform the user of a higher degree of urgency.

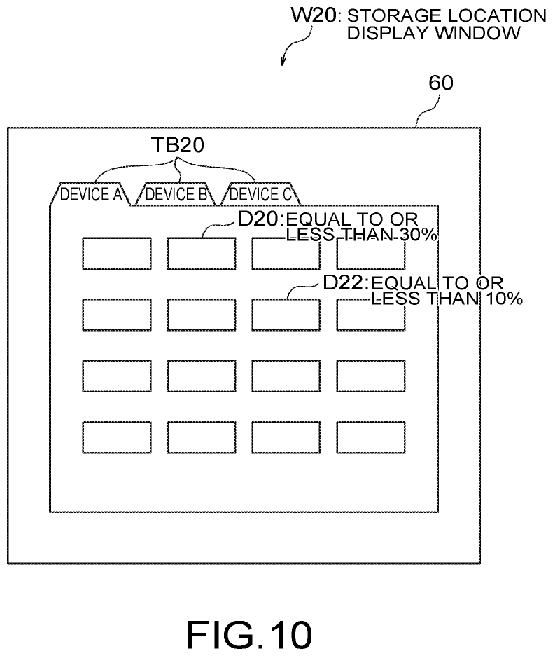

Alternatively, the reagent identification function 70b performed by the processing circuitry 70 included in the reagent management apparatus 3 may causes the display function 70c to display, on the display 60, a storage location display window W20 as shown in FIG. 10 to notify the user of the storage location of the reagent that is the same as the reagent with a decreased remaining amount. In the example of FIG. 10, the storage location of the reagent for the resupplying is notified to the user by changing the color of the lamp 74 at the storage location to be different from the color of the other lamps 74. Furthermore, the display form is changed depending on the remaining amount of the reagent. For example, if the remaining amount of the reagent is equal to or less than the first threshold value and greater than the second threshold value, the color of the reagent storage location D20 is changed to yellow and character information “30%” is displayed to give a first warning to the user to draw the user's attention. When the remaining amount of the reagent further decreases and becomes less than the second threshold value, the color of the reagent storage location D22 is changed to red and character information “10%” is displayed to give a second warning to inform the user of a higher degree of urgency.

If more than one automatic analyzers 2 are communicatively connected to the reagent management apparatus 3, the user may know whether a warning is given based on the remaining amount of each of the reagents in each of the automatic analyzer 2 by suitably selecting tabs TB20 of the storage location display window W20. In the example of FIG. 10, three automatic analyzers 2, which are a device A, a device B, and a device C, are communicatively connected to the reagent management apparatus 3, and the tab TB20 for the device A is selected to show the states of the reagents.

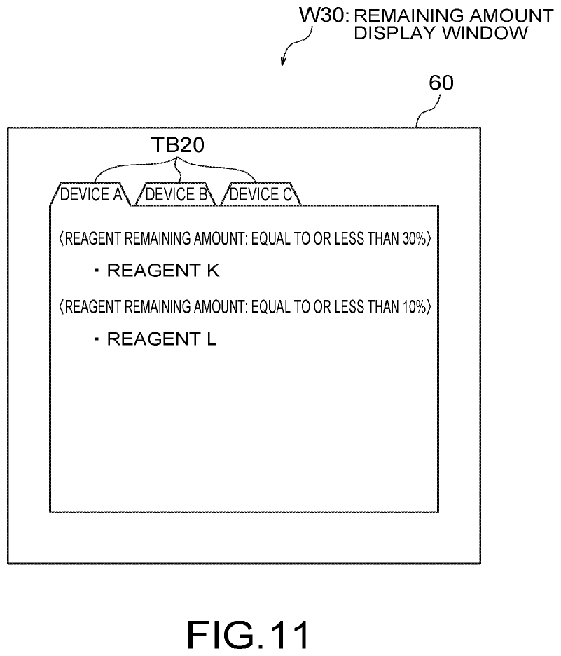

Furthermore, the reagent identification function 70b performed by the processing circuitry 70 included in the reagent management apparatus 3 may cause the display function 70c to display a remaining amount display window W30 as shown in FIG. 11 on the display 60 to notify the user of a decrease in the remaining amount of the reagent. In the example of FIG. 11, the remaining amount of a reagent K used in the automatic analyzer 2 is equal to or less than the first threshold value and greater than the second threshold value (for example, equal to or less than 30% and greater than 10%). The state of the reagent K corresponds to the first warning. The remaining amount of a reagent L used in the automatic analyzer 2 is equal to or less than the second threshold value (for example, equal to or less than 10%). The state of the reagent L corresponds to the second warning.

In this case, the lamp 74 at the storage location of a reagent that is the same as the reagent K may be turned on to emit yellow light, and the lamp 74 at the storage location of a reagent that is the same as the reagent L may be turned on to emit red light to notify the user of the storage locations of the reagents for the resupplying. The user may easily understand the storage locations of the reagents serving as the resupply of the reagent K and the reagent L in this manner.

As described above, the user may understand that any of the reagents used in the automatic analyzer 2 decreases to a certain level by means of the reagent management apparatus 3, and may be informed of the storage location of the reagent that is the same as the reagent of which the remaining amount has decreased by means of the display 60. The user then takes out the reagent for resupplying at the storage location indicated in step S24, and inputs the removal of the reagent to the reagent management apparatus 3.

In the first embodiment, the reagent management apparatus 3 detects whether the user actually takes out the required reagent by the input by the user (step S26). For example, in the first embodiment, after taking out the required reagent, the user pushes down the lamp 74 that is lighting so that the reagent management apparatus 3 may detect that the required reagent is taken out from the reagent storage 4.

If the user takes out the required reagent from the storage location corresponding to the storage location D20 indicated in the storage location display window W20 shown in FIG. 10, the user may touch the storage location D20 to input the removal of the required reagent to the reagent management apparatus 3, and if the user takes out the required reagent from the storage location corresponding to the storage location D22, the user may touch the storage location D22 to input the removal of the required reagent to the reagent management apparatus 3.

When the reagent management apparatus 3 detects the removal of the required reagent, the display function 70c performed by the processing circuitry 70 included in the management apparatus 3 displays a sign indicating that the required reagent is being resupplied, as shown in FIG. 9 (step S28). For example, in the first embodiment, when the user having taken out the reagent pushes down the lamp 74, the lamp 74 flushes on and off. In this example, when the lamp 74 is yellow to indicate the remaining amount of equal to or less than the first threshold value, the yellow lamp is flushes on and off. If the lamp 74 is red to indicate the remaining amount of equal to or less than the second threshold value, the red lamp flushes on and off.

If the storage location D20 is colored yellow in the storage location display window W20 shown in FIG. 10, the storage location D20 indicating the storage location where a reagent corresponding to the reagent with the remaining amount that is equal to or less than the first threshold value and greater than the second threshold value is placed, the yellow light at the storage location D20 may flush on and off. If the storage location D22 is colored red, the storage location D22 indicating the storage location where the reagent the remaining amount that is equal to or less than the second threshold value is placed, the red light at the storage location D22 may flush on and off.

How the reagents may be resupplied may differ depending on the types of automatic analyzers 2. For example, after taking out the required reagent from the reagent storage 4, the user may replace the reagent in the automatic analyzer 2 with the new reagent. Alternatively, after taking out the required reagent from the reagent storage 4, the user may put the reagent into the resupply reagent storage 53 (see FIG. 3) included in the automatic analyzer 2. If the required reagent is put into the resupply reagent storage 53, the new reagent is automatically replaced with the reagent being used by a mechanism included in the automatic analyzer 2 when the reagent being used is finally used up.

The automatic analyzer 2 automatically detects that the resupplying of the reagent in the automatic analyzer 2 is completed, and notifies the reagent management apparatus 3. As shown in FIG. 9, the reagent identification function 70b performed by the processing circuitry 70 included in the reagent management apparatus 3 waits until the completion of the reagent resupplying is detected (step S30: No), and when the resupplying is detected (step S30: Yes), the display of the sign indicating that the required reagent is being resupplied is erased (step S32).

The reagent identification function 70b performed by the processing circuitry 70 included in the reagent management apparatus 3 then deletes the stored reagent information of the reagent that has been taken out (step S34). The reagent resupply process according to the first embodiment is completed here, and the process proceeds to step S20 again. In step S22 described above, if it is determined that no reagent has the remaining amount of equal to or less than a predetermined value (step S22: No), the process also proceeds to step S20 and repeat the above-described steps.

As described above, the automatic analysis system 1 according to the first embodiment enables the user to know that the remaining amount of the reagent used in the automatic analyzer 2 is decreasing by the display of the display 60 included in the reagent management apparatus 3. Therefore, the reagent may be resupplied at a suitable timing. As a result, the automatic analyzer 2 is prevented from stopping due to the shortage of the reagent.

Since the reagent that should be resupplied may be indicated by the display on the display 60, the user does not need to take a note of or print the type of the reagent to be resupplied. As a result, the reagent may be resupplied in a shorter time and more accurately.

Since the reagent management apparatus 3 according to the first embodiment may be easily added to the user's own reagent storage 4, it is possible to introduce the system in a relatively inexpensive manner with the existing equipment being effectively used.

The reagent management apparatus 3 according to the first embodiment may be manufactured in various forms depending on the estimated cost. For example, in a relatively expensive form, the display 60 may include the lamps 74 and the display as shown in FIG. 4, and in a relatively inexpensive form, the display 60 may include either the lamps 74 or the display.

In addition, since the display 60 of the reagent management apparatus 3 according to the present embodiment is formed by the mobile device such a notepad or a tablet terminal, the user can carry the display 60 formed by the notepad or the tablet terminal to the automatic analyzer 2 and the user can resupply the reagent to the automatic analyzer 2 while watching the display 60.

### Second Embodiment

An automatic analysis system 1 according to a second embodiment has a function to manage the expiration dates of the reagents used in the automatic analyzers 2, the function being additionally given to the reagent management apparatus 3 according to the first embodiment described above. This improves the convenience of the users, and enables a more appropriate management of the reagents. Differences between the first embodiment and the second embodiment will be described below.

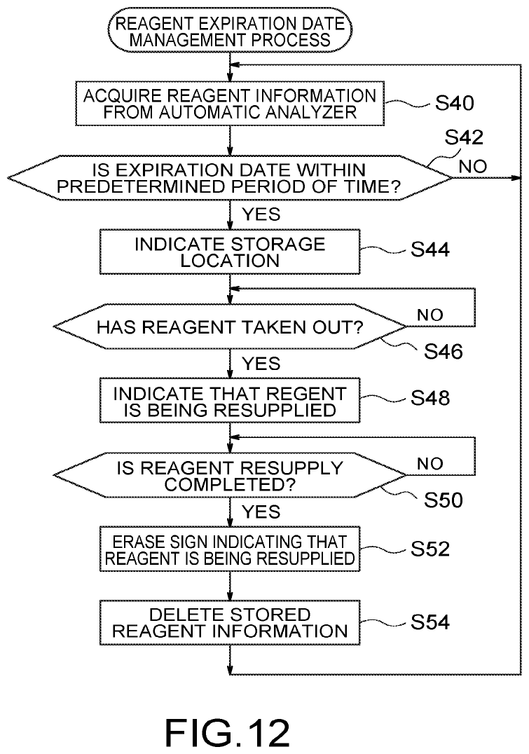

FIG. 12 is a flowchart for explaining the processing steps of a reagent expiration date management process performed by a reagent management apparatus 3 included in the automatic analysis system 1 according to the second embodiment. The reagent expiration date management process is additionally performed by the reagent management apparatus 3 according to the first embodiment.

The reagent expiration date management process is regularly performed by the reagent management apparatus 3. In the second embodiment, the reagent expiration date management process may be performed once a day, or once when the automatic analyzer 2 is activated, for example. The reagent expiration date management process is performed independently for each of the automatic analyzers 2 communicatively connected to the reagent management apparatus 3. If the reagent management apparatus 3 manages the reagents for two automatic analyzers 2, for example, two reagent resupply processes are performed in parallel. Although the reagent expiration date management process performed for a single automatic analyzer 2 managed by the reagent management apparatus 3 will be described below, in the automatic analysis system 1 according to the second embodiment shown in FIG. 1, the reagent expiration date management process is performed for each of a plurality of automatic analyzers 2.

As shown in FIG. 12, in the reagent expiration date management process, the reagent identification function 70b performed by the processing circuitry 70 included in the reagent management apparatus 3 acquires reagent information from the automatic analyzer 2 via the communicator 66 (step S40). In the second embodiment, the reagent information means reagent information for all of the reagents used in the automatic analyzer 2. The reagent information at least includes information for identifying the types of reagents and the expiration date of each of the reagents.

The reagent identification function 70b performed by the processing circuitry 70 included in the reagent management apparatus 3 then determines whether there is a reagent that needs to be resupplied by checking whether the expiration date of any of the reagents acquired in step S40 indicates that the reagent expires within a predetermined period of time (step S42). If there is a reagent with the expiration date within the predetermined period of time, i.e., if there is reagent that needs to be resupplied (step S22: Yes), the reagent identification function 70b causes the display function 70c to indicate the storage location in the reagent storage 4 where the reagent of the same type as the reagent with the expiration date within the predetermined period of time is stocked, in order to notify the user of the storage location (step S44).

The predetermined period of time in step S42 may be arbitrarily set. For example, the predetermined period of time may be set to be three days, and whether there is a reagent with the expiration date within three days may be detected. Alternatively, the period of time may be set as zero days, and whether there is a reagent that expires on the detection date may be detected. Furthermore, the predetermined period of time may be set to be minus one day, and whether there is a reagent that has expired may be detected.

The user may be notified of the storage location in various manners in step S44. For example, in the second embodiment, the lamp 74 at the storage location of the reagent for the resupplying, which is the same as the reagent with the expiration date within the predetermined period of time, may be turned on to notify the user of the storage location. Furthermore, in the second embodiment, the color of the lamp to be turned on may be changed depending on the remaining days to the expiration date of the reagent. For example, a first period of time (for example one week) and a second period of time (for example, after the expiration date) that is shorter than the first period of time may be set as the remaining days to the expiration date of the reagent. If the number of days to the expiration date of the reagent is equal to or less than the first period of time and greater than the second period of time, the lamp 74 at the storage location of the reagent may be turn on to emit yellow light to give a first warning to the user to draw the user's attention. If the number of days to the expiration date of the reagent is equal to or shorter than the second period of time, the lamp 74 at the storage location of the reagent may be turned on to emit red light to indicate a second warning to inform the user of a higher degree of urgency.

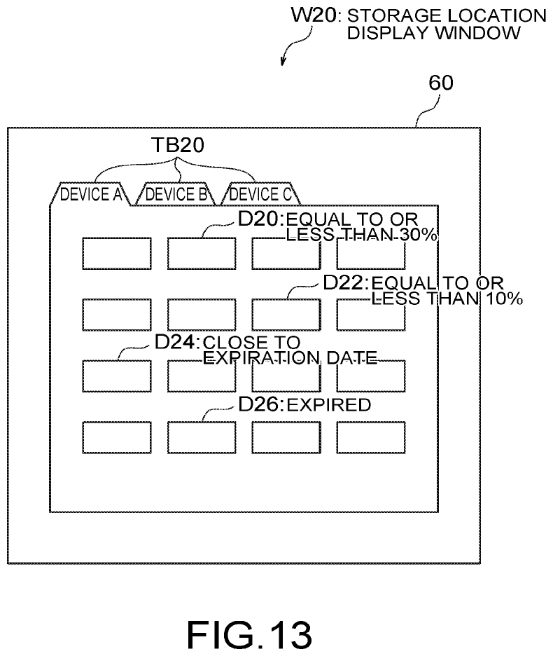

Alternatively, the display function 70c performed by the processing circuitry 70 included in the management apparatus 3 may causes the display 60 to display a storage location display window W20 as shown in FIG. 13 to notify the user of the storage location of the reagent that is the same as the reagent with the expiration date within the predetermined period of time. FIG. 13 showing the storage location display window W20 corresponds to FIG. 10 relating to the first embodiment, and additionally shows the storage location of the reagent that is the same as the reagent that will soon expire (the expiration date is within the first period of time), and the storage location of the reagent that is the same as the reagent having expired (the expiration date is within the second period of time).

In the example of FIG. 13, the user may be notified of the storage location of the reagent that is the same as the reagent with the expiration date within the predetermined period of time by a change in color of the storage location. If the color is changed depending on the remaining days to the expiration date, for example, the color of the storage location D24 may be changed to yellow with character information “close to the expiration date.” If the remaining days to the expiration date of the reagent is equal to or shorter than the first period of time and longer than the second period of time, a first warning is given to the user to draw the user's attention in this manner. If the remaining days to the expiration date of the reagent is equal to or shorter than the second period of time, the color of the storage location D26 may be changed to red with character information “expired” to give a second warning to inform the user of a higher degree of urgency.

Like the first embodiment described above, if more than one automatic analyzers 2 are communicatively connected to the reagent management apparatus 3, the user may additionally know whether a warning is given based on the expiration date of each of the reagents in each of the automatic analyzers 2 by suitably selecting tabs TB20 of the storage location display window W20. In the example of FIG. 13, three automatic analyzers 2, which are a device A, a device B, and a device C, are communicatively connected to the reagent management apparatus 3, and the tab TB20 for the device A is selected to show the states of the reagents, i.e., the remaining amount and the expiration date of each of the reagents.

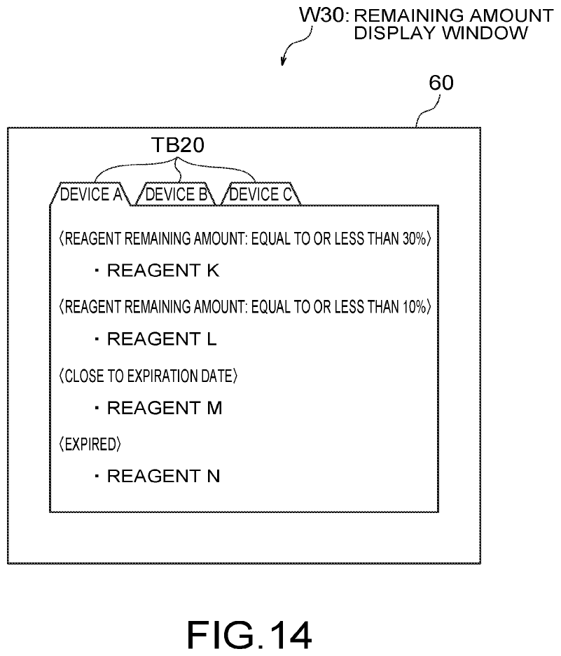

Furthermore, the display function 70c performed by the processing circuitry 70 included in the management apparatus 3 may cause the display 60 to display a remaining amount display window W30 as shown in FIG. 14 to additionally notify the user that there is a reagent with the expiration date within the predetermined period of time. In the example of FIG. 14, the expiration date of a reagent M used in the automatic analyzer 2 is within the first period of time, and beyond the second period of time. The state of the reagent M corresponds to the first warning. The expiration date of a reagent N used in the automatic analyzer 2 is within the second period of time. The state of the reagent N corresponds to the second warning.

In this case, the lamp 74 at the storage location of a reagent that is the same as the reagent M may be turned on to emit yellow light, and the lamp 74 at the storage location of a reagent that is the same as the reagent N may be turned on to emit red light to notify the user of the storage locations of the reagents for the resupplying. The user may easily understand the storage locations of the reagents serving as the resupply of the reagent M and the reagent N in this manner.

As described above, the user may understand that any of the reagents used in any of the automatic analyzers 2 is close to the expiration date by a warning from the reagent management apparatus 3, and may be informed of the storage location of the reagent that is the same as the reagent of which the expiration date is approaching. The user then takes out the reagent at the storage location indicated in step S44, and inputs the removal of the reagent to the reagent management apparatus 3.

The user then resupplies the reagent in the automatic analyzer 2, and the reagent management apparatus 3 detects the completion of the resupplying. The operation of the reagent management apparatus 3 in step S46 to step S54 in this case is the same as the operation in step S26 to step S34 of the reagent resupply process in the first embodiment. Therefore, the operation is not described in detail.

As described above, the reagent management apparatus 3 included in the automatic analysis system 1 according to the second embodiment manages the remaining amount and the expiration date of each of the reagents used in the automatic analyzer 2. The user therefore may manage the expiration date of each of the reagents easily. Specifically, the automatic analyzer 2 is prevented from stopping due to the expiration of any of the reagents used, or from performing an analysis using an expired reagent.

### Third Embodiment

An automatic analysis system 1 according to a third embodiment has a feature to automatically order a reagent that may be used up to a distributor, the feature being added to the reagent management apparatus 3 according to the first embodiment or the second embodiment described above. As a result, the reagents managed by the reagent management apparatus 3 may not be used up. Differences between the third embodiment and the first and the second embodiment will be described below.

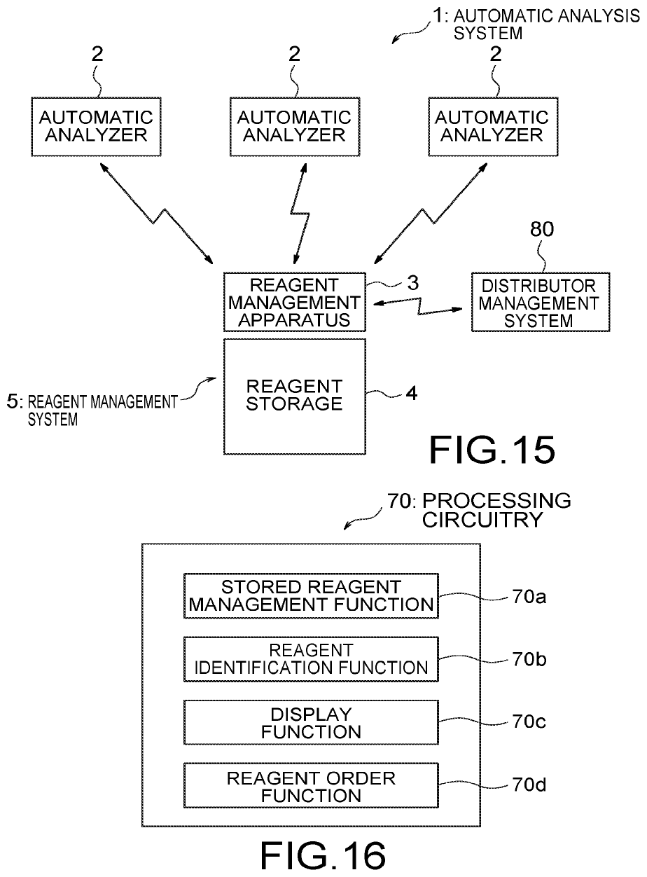

FIG. 15 is a block diagram illustrating the entire structure of the automatic analysis system 1 according to the third embodiment. FIG. 15 corresponds to FIG. 1. As shown in FIG. 15, the reagent management apparatus 3 included in the automatic analysis system 1 according to the third embodiment is connected to a distributor management system 80, which is a management system for managing reagent distributors, via a network. The distributor management system 80 receives orders for reagents from users. The reagents ordered through the distributor management system 80 are eventually delivered to the users of the reagent management apparatuses 3.

FIG. 16 is a block diagram illustrating functions performed by the processing circuitry 70 included in the reagent management apparatus 3 in the automatic analysis system 1 according to the third embodiment. FIG. 16 corresponds to FIG. 6. As shown in FIG. 16, the processing circuitry 70 of the reagent management apparatus 3 according to the third embodiment performs a reagent order function 70d in addition to the stored reagent management function 70a, the reagent identification function 70b, and the display function 70c.

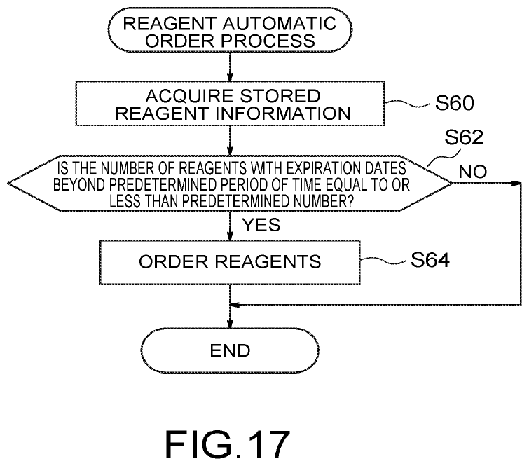

FIG. 17 is a flowchart for explaining the processing steps of a reagent automatic order process performed by the reagent management apparatus 3 included in the automatic analysis system 1 according to the third embodiment. The reagent automatic order process is additionally performed by the reagent management apparatus 3 according to the first embodiment or the second embodiment.

The reagent automatic order process is regularly performed by the reagent management apparatus 3. In the third embodiment, the reagent automatic order process may be performed once a day or once in three days. Since the reagent automatic order process is for managing the reagents in the storage managed by the reagent management apparatus 3, one reagent order process is performed for each reagent management apparatus 3.

As shown in FIG. 17, in the reagent automatic order process, the reagent order function 70d performed by the processing circuitry 70 included in the reagent management apparatus 3 acquires stored reagent information from the memory 64. The stored reagent information is reagent information relating to stored reagents in the reagent storage 4 (step S60). The stored reagent information acquired in step S60 at least includes the types of reagents and the expiration date of each of the reagents.

The reagent order function 70d performed by the processing circuitry 70 included in the reagent management apparatus 3 then determines whether the number of reagents with the expiration dates that are beyond a predetermined period of time is equal to or less than a predetermined number for each type of reagents managed by the reagent management apparatus 3 based on the stored reagent information acquired in step S60 (step S62). If the number of reagents is equal to or less than the predetermined number, the reagent order function 70d performed by the processing circuitry 70 included in the reagent management apparatus 3 orders new reagents to the distributor management system 80 (step S64).

For example, if the predetermined number is two, and two of three reagents of a type X in the reagent storage 4 will be expired within a predetermined period (for example, one week), the number of reagents of the type X with the expiration date beyond the predetermined period (for example, one week) is one, which is less than two. As a result, the reagent order function 70d performed by the processing circuitry 70 included in the reagent management apparatus 3 orders some reagents of the type X to the distributor management system 80 through the network.

The number of reagents to be newly ordered may be arbitrarily determined. For example, the number may be determined so that the predetermined number set in step S62 may be reached. In the above example, the number for reaching the predetermined number (two) is one. Therefore, one reagent is ordered. Alternatively, the number of reagents to be newly ordered may be determined by adding an extra number to the predetermined number set in step S62. If the extra number is two, three reagents is order in the above example (one plus two).

A list of the types of reagents managed by the reagent management apparatus 3 may be stored in the memory 64, for example. In this case, the types of reagents to be managed by the reagent management apparatus 3 may be determined based on the list stored in the memory 64. In step S62, whether the number of reagents that will expire after a predetermined period is equal to or less than a predetermined number is determined for each of the types of reagents based on the stored reagent information acquired in step S60.

After the order is completed in step S64, or it is determined in step S62 that the number of reagents that will expire after the predetermined period is not equal to or less than the predetermined number (step S62: No), the reagent automatic order process ends.

As described above, in the reagent management apparatus 3 included in the automatic analysis system according to the third embodiment, if the number of a certain type of reagents with the expiration dates beyond a required period of time decreases among the reagents managed by the reagent management apparatus 3, the reagent management apparatus 3 may automatically order some reagents of the same type to the distributor management system 80. As a result, a certain number of the reagents with suitable expiration dates may be always kept.

### Fourth Embodiment

An automatic analysis system 1 according to a fourth embodiment additionally has a function provided to the reagent management apparatus 3 according to any of the first embodiment to third embodiment, to display a sign indicating that a calibration may be needed when the lot number of a reagent used in the automatic analyzer 2 is different from the lot number of a reagent to be taken out for the resupplying, so as to draw the attention of the user. Differences between the automatic analysis system 1 according to the fourth embodiment and the automatic analysis system 1 according to any of the first to the third embodiment will be described below.

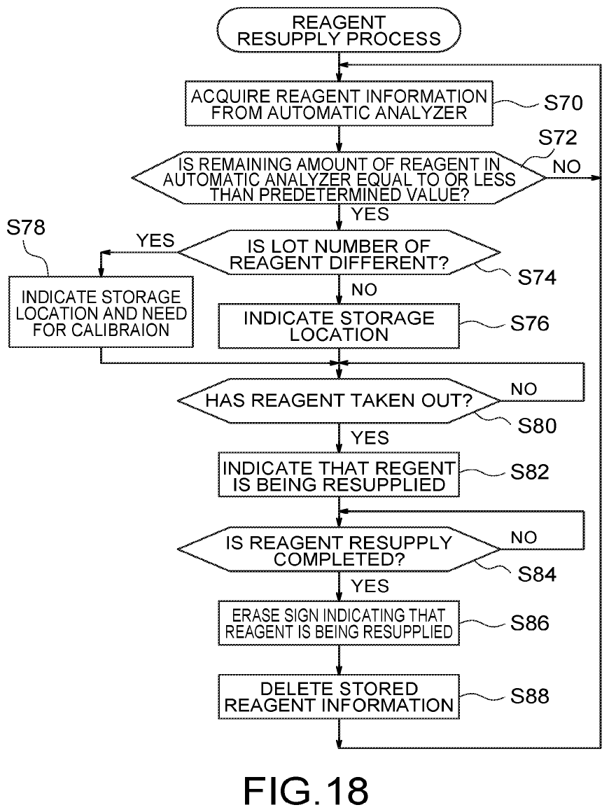

FIG. 18 is a flowchart for explaining the processing steps of a reagent resupply process performed by the reagent management apparatus 3 according to the fourth embodiment. The reagent resupply process is obtained by modifying the reagent resupply process shown in FIG. 9.

Like the reagent resupply process shown in FIG. 9, the reagent resupply process shown in FIG. 18 is regularly performed by the reagent management apparatus 3. In the fourth embodiment, the reagent resupply process is performed at predetermined intervals such as 10 minutes or one hour. The reagent resupply process is performed independently for each of the automatic analyzers 2 communicatively connected to the reagent management apparatus 3. If the reagent management apparatus 3 manages the reagents for two automatic analyzers 2, for example, two reagent resupply processes are performed in parallel. Although the reagent resupply process performed for a single automatic analyzer 2 managed by the reagent management apparatus 3 will be described below, in the automatic analysis system 1 according to the fifth embodiment shown in FIG. 1, the reagent resupply process is performed for each of a plurality of automatic analyzers 2.

As shown in FIG. 18, in the reagent resupply process, the reagent identification function 70b performed by the processing circuitry 70 included in the reagent management apparatus 3 acquires reagent information from the automatic analyzer 2 via the communicator 66 (step S70). In the fourth embodiment, the reagent information means reagent information for all of the reagents used in the automatic analyzer 2. The reagent information at least includes information for identifying the types of reagents, the remaining amount of each of the reagents, and the lot number of each of the reagents.

The reagent identification function 70b performed by the processing circuitry 70 included in the reagent management apparatus 3 then determines whether there is a reagent that needs to be resupplied by checking whether the remaining amount of any of the reagent acquired in step S70 is equal to or less than a predetermined value (step S72). If there is a reagent that needs to be resupplied (step S72: Yes), the reagent identification function 70b determines, based on the stored reagent information, the lot number of a reagent stored in the reagent storage 4, the reagent being of the same type as the reagent with the remaining amount equal to or less than the predetermined value. The reagent identification function 70b further determines whether the determined lot number is the same as the lot number of the reagent acquired in step S70 (step S74).

If the lot number of the reagent stored in the reagent storage 4 is not different from the lot number of the reagent with the remaining amount being equal to or less than the predetermined value, i.e., if they have the same lot number (step S74: No), the reagent identification function 70b performed by the processing circuitry 70 included in the reagent management apparatus 3 causes the display function 70c to display the storage location in the reagent storage 4 where the reagent of the same type as the reagent with the remaining amount being equal to or less than the predetermined value is stored, as in the first embodiment, and notify the user of the storage location (step S76).

If the lot number of the reagent stored in the reagent storage 4 is different from the lot number of the reagent with the remaining amount being equal to or less than the predetermined value (step S74: Yes), the reagent identification function 70b performed by the processing circuitry 70 included in the reagent management apparatus 3 causes the display function 70c to display the storage location in the reagent storage 4 where the reagent of the same type as the reagent with the remaining amount being equal to or less than the predetermined value is stored, and also a sign indicating that a calibration is needed (step S78).

For example, if the calibration may be needed in the fourth embodiment, the lamp 74 at the storage location of the reagent for the resupplying may emit brighter light or emit light with a different color to notify to the user that a calibration may be needed.

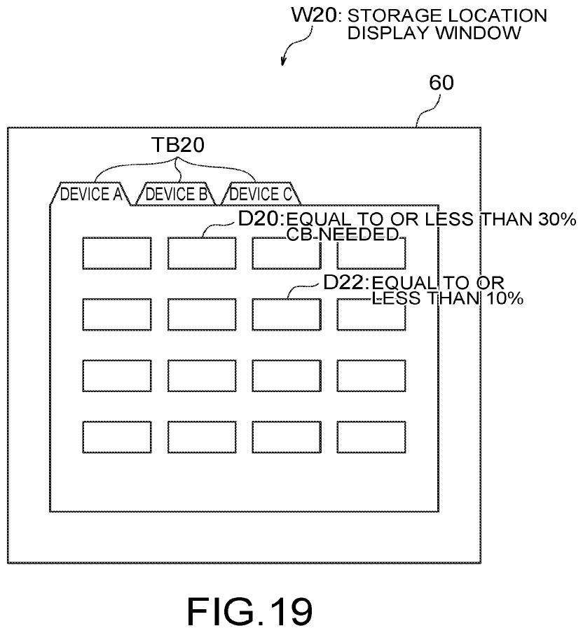

Alternatively, the reagent the display function 70c performed by the processing circuitry 70 included in the management apparatus 3 may cause the display 60 to display a storage location display window W20 as shown in FIG. 19 to notify the user of the necessity of a calibration when a reagent is to be resupplied. In the example of FIG. 19, the color of the storage location D20 in the storage location display window W20 may be changed like the storage location display window W20 shown in FIG. 10, and also character information “CB NEEDED” is added to the storage location D20 to notify the user of the necessity of the calibration. The user may understand the necessity of a calibration when taking out a reagent from the storage location D20.

If the display form is changed in accordance with the remaining amount of the reagent like the example shown in FIG. 10, character information “CB NEEDED” may be added to the yellow-colored storage location D20 indicating that the remaining amount of the reagent is equal to or less than the first threshold value and greater than the second threshold value, to notify the user of the necessity of the calibration.

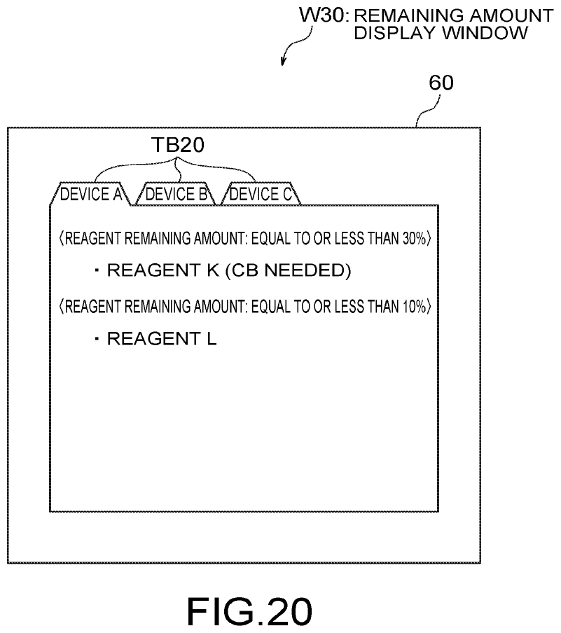

The reagent the display function 70c performed by the processing circuitry 70 included in the management apparatus 3 may display a remaining amount display window W30 as shown in FIG. 20 on the display 60 to notify the user of the necessity of the calibration. In the example of FIG. 20, character information “(CB NEEDED)” is added to the information on the remaining amount in the remaining amount display window W30 shown in FIG. 11 to notify the user of the necessity of the calibration. As a result, the user may understand that a calibration may be needed when the reagent K being used is replaced with a new reagent K.

The lamp 74 at the storage location of the reagent K may be caused to emit a brighter yellow light in this case than the case where no calibration is needed. As a result, the user may easily understand the storage location of the reagent K in the reagent storage 4, and also the necessity of a calibration.

The user may understand that the remaining amount of the reagent used in the automatic analyzer 2 is decreasing and also understand whether a calibration may be needed when step S78 or step S76 is performed by means of the reagent management apparatus 3. The user then takes out the reagent at the storage location displayed on the display 60 of the reagent management apparatus 3, and inputs the removal of the reagent to the reagent management apparatus 3.

In the fourth embodiment, the reagent management apparatus 3 determines whether the user has actually taken out the reagent (step S80). After step S80, the same steps as step S26 to step S34 in the reagent resupply process shown in FIG. 9 are performed until step S88. Therefore, detailed descriptions of such steps are not provided.

As described above, in the automatic analysis system 1 according to the fourth embodiment, the display 60 of the reagent management apparatus 3 displays a sign indicating that a reagent may need a calibration. Therefore, the user may easily and accurately understand whether a calibration may be needed with respect to a reagent for the resupplying.

### Fifth Embodiment

A automatic analysis system 1 according to a fifth embodiment has a function to predict whether a reagent used in the automatic analyzer 2 may be used up within that day in addition to the functions of the reagent management apparatus 3 according to any of the first to the fourth embodiment. This may prevent the automatic analyzer 2 from stopping due to the shortage of the reagent. Differences between the automatic analysis system 1 according to the fourth embodiment and the automatic analysis system 1 according to any of the first to the fourth embodiment will then be described below.

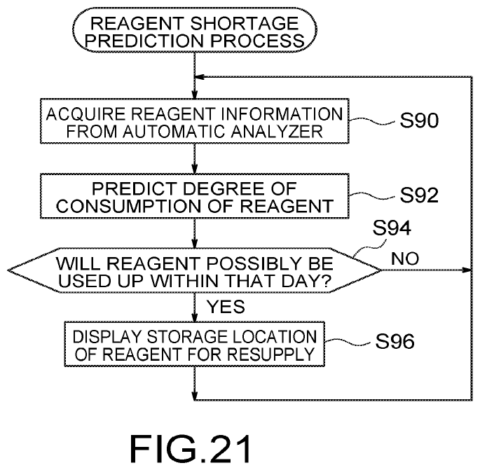

FIG. 21 is a flowchart for explaining the processing steps of a reagent shortage prediction process performed in the reagent management apparatus 3 according to the fifth embodiment. The reagent shortage prediction process is performed in addition to the processes performed by the reagent management apparatus 3 in any of the first to the fourth embodiment.

The reagent shortage prediction process is regularly performed at the reagent management apparatus 3. In the fifth embodiment, the reagent shortage prediction process is performed at predetermined intervals such as one day or 12 hours. The reagent shortage prediction process is performed independently for each of the automatic analyzers 2 communicatively connected to the reagent management apparatus 3. If the reagent management apparatus 3 manages the reagents for two automatic analyzers 2, for example, two reagent shortage prediction processes are performed in parallel. Although the reagent shortage prediction process performed for a single automatic analyzer 2 managed by the reagent management apparatus 3 will be described below, the automatic analysis system 1 according to the fifth embodiment may perform the reagent shortage prediction process for each of a plurality of automatic analyzers 2.

As shown in FIG. 21, in the reagent shortage prediction process, the reagent identification function 70b performed by the processing circuitry 70 included in the reagent management apparatus 3 acquires reagent information from the automatic analyzer 2 via the communicator 66 (step S90). In the fifth embodiment, the reagent information means reagent information for all of the reagents used in the automatic analyzer 2. The reagent information at least includes information for identifying the types of reagents and the remaining amount of each of the reagents.

The reagent identification function 70b performed by the processing circuitry 70 included in the reagent management apparatus 3 then predicts the degree of decrease of each of the reagents (step S92), and determines whether a reagent may possibly be used up within that day (step S94).

Specifically, the reagent identification function 70b predicts the degree of consumption of the reagent during that day and determines whether the reagent may be used up within that day based on the information on the remaining amount of the reagent acquired in step S90 and the amount of average consumption of that type of reagent in a day in the past. The daily consumption of reagent differs depending on the type of reagent. Therefore, in the fifth embodiment, the reagent identification function 70b performed by the processing circuitry 70 included in the reagent management apparatus 3 causes the memory 64 to store the remaining amount of each reagent acquired from the automatic analyzer 2 in each day so that an average consumption of that type of reagent in the past may be calculated. If the remaining amount of a reagent acquired in step S90 is less than the average daily consumption in the past, the reagent identification function 70b determines that the reagent may be used up during that day.

Of course, the prediction does not need to be performed based on the average daily consumption in the past. For example, if the processing circuitry 70 included in the reagent management apparatus 3 has an artificial intelligence (AI) function, the consumption of the reagent during that day may be calculated using the AI function and the consumed amount per day in the past, and whether a reagent may be used up during that day may be determined. With this method, it is possible to calculate a daily consumption in consideration of various factors such as days, seasons, and holidays in predicting whether a reagent may be used up.

As a result of step S92 and step S94, if it is determined that a reagent may be used up during that day (step S94: Yes), the reagent identification function 70b performed by the processing circuitry 70 included in the reagent management apparatus 3 causes the display function 70c to display on the display 60 the storage location of the reagent for the resupplying, which will be replaced with the reagent stored in the automatic analyzer 2 (step S96). For example, the display function 70c causes the lamp 74 at the storage location of the corresponding reagent to emit orange light to notify the user of the storage location of the reagent of the same type as the reagent that may possibly be used up during that day.

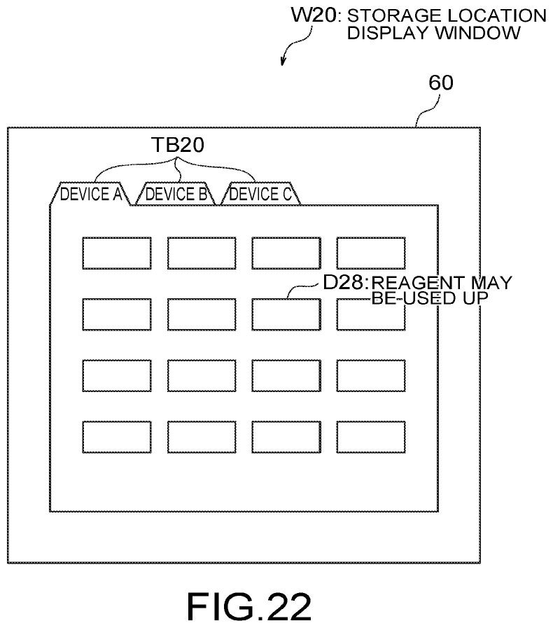

Alternatively, the reagent the display function 70c performed by the processing circuitry 70 included in the management apparatus 3 may cause the display 60 to display a storage location display window W20 as shown in FIG. 22 to notify the user of the storage location of the reagent of the same type as the reagent that may possibly be used up during that day. In the example of FIG. 22, the color of the storage location D28 where the reagent of the same type as the reagent that may possibly be used up is stored is different from the color of the storage locations where the other reagents are stored. In the fifth embodiment, character information “REAGENT MAY BE USED UP” is additionally displayed on the storage location D28 to draw the user's attention.

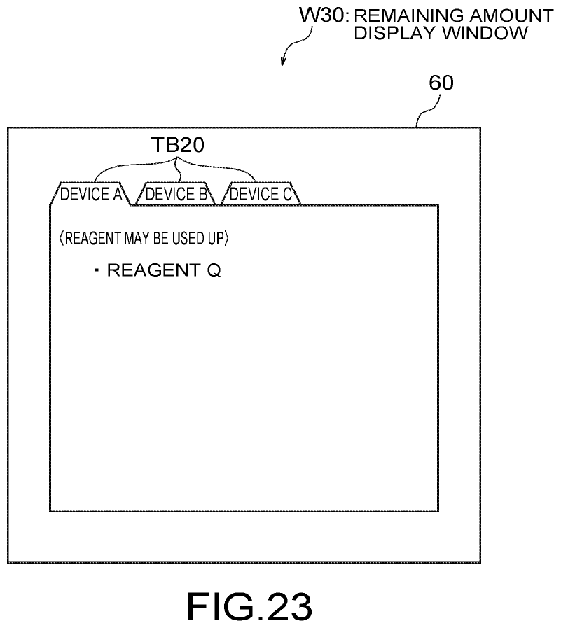

Furthermore, the reagent the display function 70c performed by the processing circuitry 70 included in the management apparatus 3 may cause the display 60 to display a remaining amount display window W30 as shown in FIG. 23 to notify the user that there is a reagent that may be used up during that day. In the example of FIG. 23, the reagent Q used in the automatic analyzer 2 is indicated as being possibly used up during that day. However, this display alone does not indicate the storage location in the reagent storage 4 where a reagent of the same type as the reagent Q is stored. Therefore, the lamp 74 at the storage location where the reagent of the same type as the reagent Q is stored may be tuned on to emit orange light to notify the storage location of the reagent to the user. As the result, the user may easily understand the storage location of the reagent of the same type as the reagent Q.

After taking out the required reagent from the reagent storage 4, the user may replace the reagent being used with the reagent taken out, or store the reagent taken out to the resupply reagent storage 53 included in the automatic analyzer 2 (see FIG. 3). If the reagent is stored in the resupply reagent storage 53, the automatic analyzer 2 automatically replaces the used up reagent with the new reagent and continues the analysis operation.

As described above, in the automatic analysis system 1 according to the fifth embodiment, a reagent that may be used up during the day may be determined based on the remaining amount of the reagent included in the reagent information acquired from the automatic analyzer 2 and a predicted consumption of the reagent of the same type. The user may be notified of the reagent that may possibly be used up. Therefore, the possibility that any of the reagents in the automatic analyzer 2 in operation may be used up may be decreased.

### Sixth Embodiment

In the above-described embodiments, one lamp 74 is provided for one storage location for a reagent on the shelves 72 of the reagent storage 4. Thus, the lamps 74 and the reagent storage locations have a one-to-one relationship. In contrast, in a sixth embodiment, one lamp 74 is provided for two storage locations of the reagents on the shelves 72 of the reagent storage 4. Differences between the automatic analysis system 1 according to the sixth embodiment and the automatic analysis system 1 according to any of the first to the fifth embodiment will be described below.

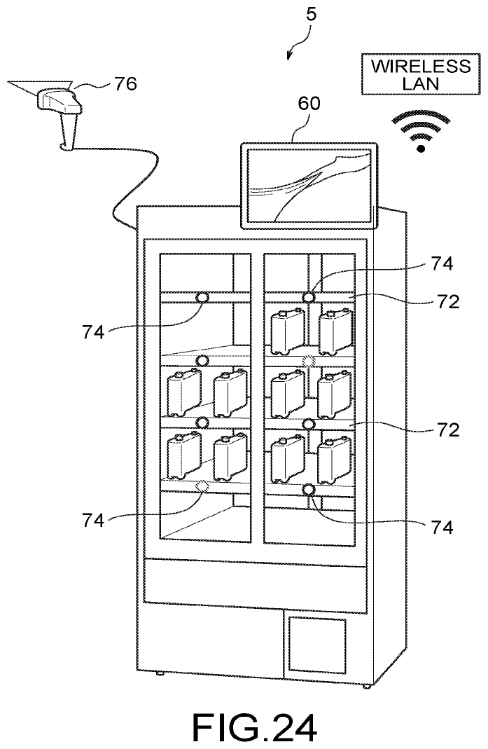

FIG. 24 is a perspective view showing an example of the structure of a reagent management system 5 in the automatic analysis system 1 according to the sixth embodiment. FIG. 24 corresponds to FIG. 4 described above. As shown in FIG. 24, in a reagent management apparatus 3 included in the reagent management system 5 according to the sixth embodiment, one lamp 74 is provided for two reagent storage locations. Thus, the lamps 74 and the reagent storage locations have a one-to-two relationship.

Each lamp 74 is disposed between two reagent storage locations on the shelves 72. The user and the reagent management apparatus 3 need to perform a management operation so that two reagent storage locations that share the one lamp 74 have the same type of reagent. When a lamp 74 is turned on to notify the user of the storage location of a reagent to be taken out, and two reagents are placed on the shelf where the lamp 74 is located, the user may take out either of the two reagents to be conveyed to the automatic analyzer 2.

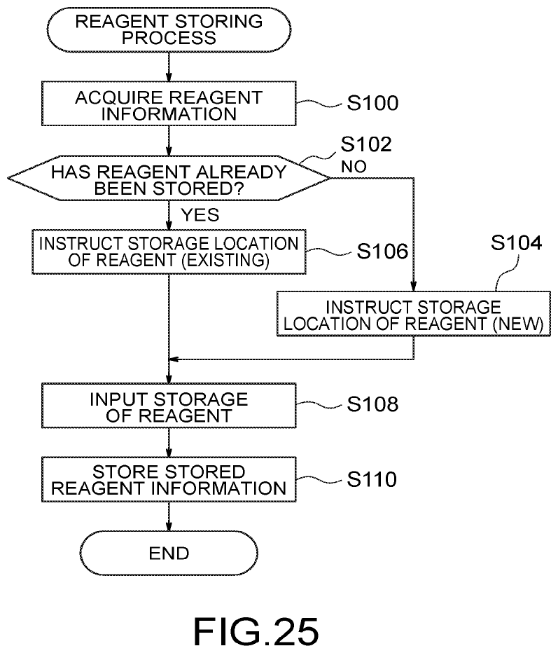

FIG. 25 is a flowchart for explaining the processing steps of a reagent storing process performed by the reagent management apparatus 3 included in the automatic analysis system 1 according to the sixth embodiment. FIG. 25 corresponds to FIG. 7. The reagent storing process is performed when the user stores a new reagent in the reagent storage 4. In the sixth embodiment, the reagent storing process is performed when, for example, the user commands the activation of the reagent storing process through the input interface 62 when storing a new reagent in the reagent storage 4.

As shown in FIG. 25 in the reagent storing process, the stored reagent management function 70a performed by the processing circuitry 70 included in the reagent management apparatus 3 acquires reagent information of a reagent to be newly stored in the reagent storage 4 (step S100). This step is the same as step S10 shown in FIG. 7.

The stored reagent management function 70a performed by the processing circuitry 70 included in the reagent management apparatus 3 then determines whether the type of the reagent the user is going to store in the reagent storage 4 is the same as the type of the reagent that is already stored in the reagent storage 4 based on the reagent information acquired in step S100 (step S102). Specifically, the stored reagent management function 70a determines whether the type of the reagent acquired in step S100 is included in the stored reagent information stored in the memory 64.

If the reagent storage 4 does not have the type of the reagent which the user intends to store in the reagent storage 4 (step S102: No), the stored reagent management function 70a informs the user of the storage location of the reagent (step S104). This step is similar to step S12 shown in FIG. 7. However, it is necessary to inform the user of storage locations sharing one lamp 74 for storing the new reagent.

If the reagent storage 4 has the type of the reagent which the user intends to store (step S102: Yes), the stored reagent management function 70a informs the user of the location of the lamp 74 indicating the storage locations of the same type of reagent. Specifically, if the storage location that shares the lamp 74 with the storage location where the same type of reagent is stored is vacant, the lamp 74 is turned on to emit green light, and the user is instructed to store the new reagent to the vacant storage location where the lamp 74 is emitting green light. If the storage location that shares the lamp 74 with the storage location where the same type of reagent is stored is not vacant, a lamp 74 shared by two vacant storage locations is turned on to emit green light, and the user is instructed to store the new reagent at one of the vacant storage locations. Thus, in the sixth embodiment, the user is informed of the storage location so that reagents of the same type are stored at storage locations sharing one of the lamps 74.

The stored reagent management function 70a performed by the processing circuitry 70 included in the reagent management apparatus 3 then instructs the user to input the completion of the storage of the reagent so as to detect the storage of the reagent at the instructed storage location (step S108). This step corresponds to step S14 shown in FIG. 7.

The stored reagent management function 70a performed by the processing circuitry 70 included in the reagent management apparatus 3 then causes the memory 64 to store information on the storage location of the reagent together with the reagent information of the reagent. Such information is regarded as stored reagent information (step S110). This step corresponds to step S16 shown in FIG. 7. By performing step S110, the reagent storing process according to the sixth embodiment is completed.

The instruction of the storage location of the reagent in step S104 may be omitted in the reagent storing process. In this case, the user knows that the new reagent may be placed at an arbitrary storage location since no lamp 74 is turned on after the user reads the reagent information of the reagent to be stored by means of a barcode reader 76 in step S100. The user then selects storage locations sharing one lamp 74 on a shelf 72, both of the storage locations being vacant, and stores the new reagent at one of the storage locations. The user may input the storage location to the reagent management apparatus 3 by pushing down the lamp 74 of the storage location in step S108. The reagent management apparatus 3 then associates the reagent information with the storage location of the reagent as stored reagent information, and causes the memory 64 to store the stored reagent information.

Except for the reagent storing process, the automatic analysis system 1 according to the sixth embodiment performs the same processes as the automatic analysis system 1 according to any of the first to the fifth embodiment.

As described above, in the automatic analysis system 1 according to the sixth embodiment, each of the lamps 74 is shared by two storage locations in the shared reagent storage 4. Therefore, the number of lamps 74 may be reduced, and the costs of the reagent management apparatus may be reduced.

### Seventh Embodiment

Although the lamps 74 provided on the reagent management apparatus 3 emit the green light, the yellow light or the red light in the embodiments mentioned above, the lamps 74 of the reagent management apparatus 3 according to a seventh embodiment additionally have a function to display character information as well. Hereinafter, the seventh embodiment will be explained as a modification of the first embodiment. However, also in the embodiments of the second embodiment through the sixth embodiment, the lamps 74 may additionally have the function to display the character information by modifying them in the same manner.

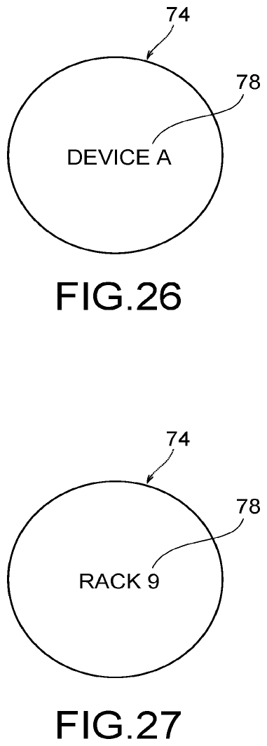

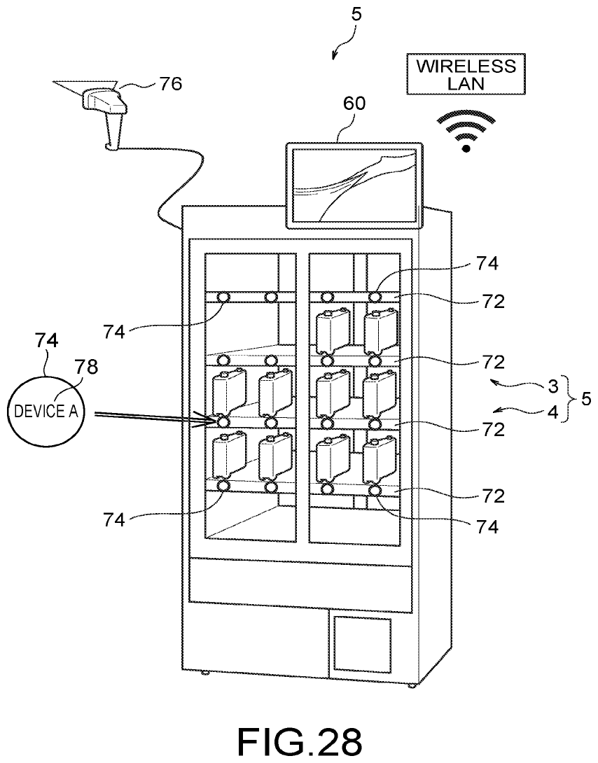

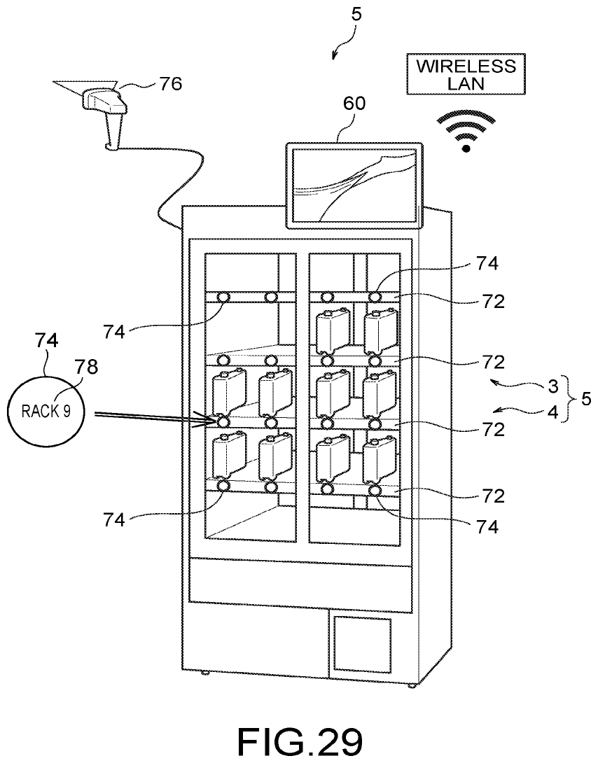

Each of FIG. 26 and FIG. 27 is an enlarged diagram of a lamp 74 of the reagent management apparatus 3 according to the seventh embodiment. FIG. 28 is a perspective view showing an example of the structure of the reagent management system 5 in which one of the lamps 74 is emitting as shown in FIG. 26. FIG. 29 is a perspective view showing an example of the structure of the reagent management system 5 in which one of the lamps 74 is emitting as shown in FIG. 27. Also, FIG. 28 and FIG. 29 correspond to FIG. 4 in the first embodiment mentioned above.

As shown in FIG. 26 and FIG. 27, in the present embodiment, the lamp 74 displays the character information 78. Here, the character information should be interpreted as broad meanings including, for example, alphabets, numerals, and signs.

The lamp 74 as shown in FIG. 26 and FIG. 28 displays the character information 78 to specify an automatic analyzer 2 to which the reagent should be resupplied. More specifically, in step S22 of the reagent resupply process, when the lamp 74 emits the yellow right or the red right, the lamp 74 also displays the character information 78 as information to specify the automatic analyzer 2 to which the reagent should be resupplied. In an example of FIG. 26 and FIG. 28, the user can understand that the reagent at the storage location where the lamp 74 is emitting should be resupplied to the device A.

The lamp 74 as shown in FIG. 27 and FIG. 29 displays the character information 78 to specify the storage location of the reagent in the reagent storage 4. For example, in the present embodiment, serial numbers are assigned to the storage locations for the reagents on the shelves 72, and thus the assigned serial numbers are displayed on the lamps 74. In an example of FIG. 27 and FIG. 29, since the number 9 is assigned to the storage location of the lamp 74 in the drawing, the character information of “RACK 9” is displayed. As a result, the user can steadily know information to specify the storage locations in the reagent storage 4.

The character information 78 displayed on the lamp 74 can be switched by, for example, the user's operation of the storage location display window W20 shown in FIG. 10. For example, by the user's operation of the tab TB20 of the device A, among the lamps 74 provided on the reagent management apparatus 3, the lamp 74 positioned at the storage location of the reagent to be resupplied to the device A displays the character information 78 to specify the automatic analyzer 2 to which that reagent should be resupplied as shown in FIG. 26 whereas the lamps 74 positioned at the other locations display the character information 78 to specify the storage location of the reagents as shown in FIG. 27.

Also, even if the lamp 74 displays the character information 78 to specify the automatic analyzer 2 to which the reagent should be resupplied, the lamp 74 may alternately display the character information 78 to specify the automatic analyzer 2 to which the reagent should be resupplied as shown in FIG. 26 and the character information 78 to specify the storage location of the reagent as show in FIG. 27.

For example, it can be implemented by the reagent identification function 70b of the processing circuitry 70 to specify the automatic analyzer 2 to which the reagent to be taken should be resupplied. Then, the reagent identification function 70b of the processing circuitry 70 causes the lamp 74 to display the information to specify the specified automatic analyzer 2 via the display function 70c.

Incidentally, the information to specify the automatic analyzer 2 to which the reagent taken out should be resupplied is not limited to the character information 78. For example, the information to specify the automatic analyzer 2 to which the reagent taken out may be output as a guiding voice by pressing the lamp 74 emitting light by the user.

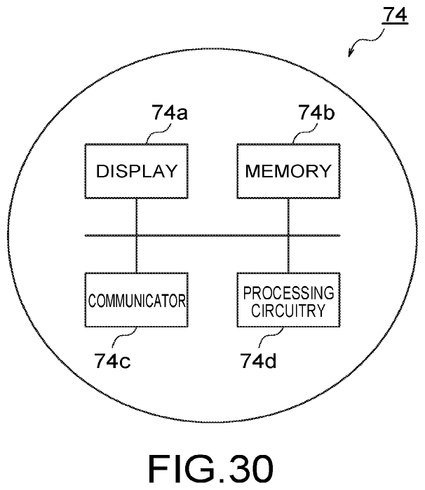

FIG. 30 is a block diagram illustrating an example of an internal configuration of the lamp 74 according to the seventh embodiment. As shown in FIG. 7, the lamp 74 according to the present embodiment includes a display 74a, a memory 74b, a communicator 74c and processing circuitry 74d.

The display 74a displays the character information 78 mentioned above. Examples of the display 74a includes a small type of a liquid crystal display, a matrix-arranged LEDs (Light Emitting Diodes), and so on.

Examples of the memory 74b include a small type of a semiconductor memory device such as a random access memory (RAM) and a flash memory. In the present embodiment, the memory 74b stores the character information 78 to be displayed on the display 74a, programs necessary for controlling the display 74a, and so on.

Examples of the communicator 74c include a wireless communication interface and a wired communication interface. More specifically, in the present embodiment, the communicator 74c communicates with the communicator 66 of the reagent management apparatus 3 and receives the character information 78 to be displayed on the display 74a from the reagent management apparatus 3.

Examples of the processing circuitry 74d include a processor. More specifically, in the present embodiment, the processing circuitry 74d reads out the programs from the memory 74b and then controls the character information 78 displayed on the display 74a.

### Eighth Embodiment

Although the display 60 of the reagent management apparatus 3 is placed at the reagent storage 4 in the embodiments mentioned above, a function to display information of the reagent management apparatus 3 is introduced to the automatic analyzer 2 in addition to the display 60 at the reagent storage 4 or instead of the display 60 at the reagent storage 4 in an eighth embodiment. Hereinafter, the eighth embodiment will be explained as a modification of the first embodiment. However, also in the embodiments of the second embodiment through the seventh embodiment, the function to display information of the reagent management apparatus 3 may be introduced to the automatic analyzer 2 by modifying them in the same manner.

As explained in FIG. 2, the automatic analyzer 2 according to the present embodiment includes the display 10. Therefore, in the present embodiment, various information displayed on the display 60 of the reagent management apparatus 3 can be displayed on the display 10 of the automatic analyzer 2. That is, the display 10 displays not only the information on the automatic analyzer 2 but also the information on the reagent management apparatus 3.

The information to be displayed on the display 10 placed at the automatic analyzer 2 can be acquired by communication with the communicator 16 of the automatic analyzer 2 in FIG. 2 and the communicator 66 of the reagent management apparatus 3 in FIG. 5. Incidentally, an additional display for the reagent management apparatus 3 may be placed in the automatic analyzer 2 in addition to the display 10.

For example, the display 10 placed at the automatic analyzer 2 can display the storage location display window W20 shown in FIG. 10 and the remaining amount display window W30 as shown in FIG. 11, and switch the automatic analyzer 2 to be displayed by the operation of the tab TB20 on the storage location display window W20 and the remaining amount display window W30. Especially, in the present embodiment, the user in front of the automatic analyzer 2 can check the situations of the remaining amount of the reagents of the automatic analyzer 2 with the display 10. In addition, the user in front of the automatic analyzer 2 can check the stock situations of the reagents in the reagent storage 4.

Also, in the present embodiment, as mentioned in the first embodiment, the display 10 may be formed by the mobile device such a notepad or a tablet terminal. In this case, the user can detach the display 10 and carry the display 10 to another automatic analyzer 2 or to the reagent storage 4. Then, the user can specify the storage location of the reagent to be resupplied by displaying the storage location display window W20 on the detached display 10. As a result, the user does not need to take a note of or print the type of the reagent to be resupplied by the user.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A reagent management apparatus comprising:
a communicator configured to communicate with an automatic analyzer to acquire reagent information on reagents in the automatic analyzer;
a memory configured to store stored reagent information on reagents in a reagent storage and the reagent information on the reagents in the automatic analyzer; and
a stored reagent manger to manage the stored reagent information on the reagents in the reagent storage and the reagent information on the reagents in the automatic analyzer stored in the memory.

2. The reagent management apparatus according to claim 1, further comprising:
a reagent identifier to identify a reagent to be taken out of the reagent storage based on the stored reagent information on the reagents in the reagent storage and the reagent information on the reagents in the automatic analyzer; and
a display to display information on the reagent to be taken identified by the reagent identifier.

3. The reagent management apparatus according to claim 1, wherein the stored reagent manager is further configured to determine a type of a reagent by acquiring the reagent information of the reagent to be stored in the reagent storage and to indicate a location where the reagent is to be stored.

4. The reagent management apparatus according to claim 3, wherein the stored reagent manager acquires the reagent information on the reagent to be stored in the reagent storage by causing a barcode reader to read a barcode on a container of the reagent.

5. The reagent management apparatus according to claim 3, wherein the stored reagent manager checks whether the reagent is stored in the location indicated, and then causes the memory to store the storage location and the type of the reagent as the stored reagent information.

6. The reagent management apparatus according to claim 2, wherein the reagent identifier determines a remaining amount of the reagent based on the reagent information on the reagents in the automatic analyzer acquired from the communicator, and determines the reagent for resupplying based on the remaining amount of the reagent.

7. The reagent management apparatus according to claim 6, wherein the reagent identifier causes the display to display a first warning when the remaining amount of the reagent is equal to or less than a first threshold value and greater than a second threshold value that is lower than the first threshold value, and to display a second warning when the remaining amount of the reagent is equal to or less than the second threshold value.

8. The reagent management apparatus according to claim 2, wherein the reagent identifier also identifies a storage location where a reagent to be taken out of the reagent storage is stored, and causes the display to display the storage location determined.

9. The reagent management apparatus according to claim 8, wherein the reagent identifier detects that the reagent has been taken out of the reagent storage, and causes the display to display a sign indicating that the reagent is being resupplied.

10. The reagent management apparatus according to claim 9, wherein the reagent identifier detects that resupplying of the reagent taken out is completed, and deletes the stored reagent information of the reagent.

11. The reagent management apparatus according to claim 2, wherein the reagent identifier identifies the reagent having an expiration date within a predetermined period of time based on the reagent information on the reagents in the automatic analyzer, and causes the display to display the reagent.

12. The reagent management apparatus according to claim 2, wherein the reagent identifier identifies the reagent that has expired based on the reagent information on the reagents in the automatic analyzer, and causes the display to display the reagent.

13. The reagent management apparatus according to claim 2, further comprising a reagent orderer to order a new reagent based on the stored reagent information.

14. The reagent management apparatus according to claim 13, wherein the reagent orderer orders the new reagent when the number of reagents having expiration dates beyond a predetermined period of time is equal to or less than a predetermined number.

15. The reagent management apparatus according to claim 2, wherein the reagent identifier causes the display to display a sign indicating that a calibration is needed when a lot number of the reagent to be taken out is different from a lot number of a reagent used in the automatic analyzer.

16. The reagent management apparatus according to claim 2, wherein the reagent identifier identifies the reagent that may be used up within a day based on a remaining amount included in the reagent information on the reagents in the automatic analyzer and a daily consumption in the past, and causes the display to display the reagent identified.

17. The reagent management apparatus according to claim 2, wherein:
the communicator communicates with one or more automatic analyzers;
the memory independently stores the reagent information of the reagents in each of the automatic analyzers; and
the reagent identifier identifies the reagent to be taken out of the reagent storage of each of the automatic analyzers.

18. The reagent management apparatus according to claim 6, wherein the reagent identifier also identifies an automatic analyzer to which a reagent to be taken out of the reagent storage is supplied, and causes the display to display information to specify the specified automatic analyzer.

19. A reagent management system comprising:
a reagent management apparatus according to claim 1; and
a reagent storage to store the reagents, wherein the reagent management apparatus is installed to the reagent storage in order to manage the reagents stored in the reagent storage.

20. An automatic analyzer, comprising:
a communicator configured to communicate with a reagent management apparatus which manages stored reagent information on reagents in a reagent storage and reagent information on reagents in the automatic analyzer; and
a display configured to display the stored reagent information on the reagents in the reagent storage and the reagent information on the reagents in the automatic analyzer.
